(19) United States
(12) Patent Application Publication
(10) Pub. No.: US 2024/0121710 A1
(43) Pub. Date: Apr. 11, 2024

(54) USER EQUIPMENT SLICE-SPECIFIC CELL SELECTION AND RESELECTION

(71) Applicant: QUALCOMM Incorporated, San Diego, CA (US)

(72) Inventors: Peng CHENG, Beijing (CN); Ozcan OZTURK, San Diego, CA (US); Jianhua LIU, Beijing (CN); Xipeng ZHU, San Diego, CA (US)

(21) Appl. No.: 18/263,487

(22) PCT Filed: Apr. 1, 2021
(86) PCT No.: PCT/CN2021/084861

§ 371 Date: Jul. 28, 2023

(51) Int. Cl. H04W 48/20

(52) U.S. Cl. CPC H04W 48/20

(57) ABSTRACT

Various aspects of the present disclosure generally relate to wireless communication. In some aspects, a user equipment (UE) may receive, from a base station, supported slice information. The UE may perform, in connection with a determination that one or more intended slices for the UE include a high priority slice, at least one of cell selection or cell reselection based at least in part on the supported slice information. Numerous other aspects are described.

### FIELD OF THE DISCLOSURE

Aspects of the present disclosure generally relate to wireless communication and to techniques and apparatuses for user equipment (UE) slice-specific cell selection and reselection.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving, from a base station, supported slice information; and performing, in connection with a determination that one or more intended slices for the UE include a high priority slice, at least one of cell selection or cell reselection based at least in part on the supported slice information.

In some aspects, a UE for wireless communication includes a memory and one or more processors, coupled to the memory, configured to: receive, from a base station, supported slice information; and perform, in connection with a determination that one or more intended slices for the UE include a high priority slice, at least one of cell selection or cell reselection based at least in part on the supported slice information.

In some aspects, a non-transitory computer-readable medium storing a set of instructions for wireless communication includes one or more instructions that, when executed by one or more processors of a UE, cause the UE to: receive, from a base station, supported slice information; and perform, in connection with a determination that one or more intended slices for the UE include a high priority slice, at least one of cell selection or cell reselection based at least in part on the supported slice information.

In some aspects, an apparatus for wireless communication includes means for receiving, from a base station, supported slice information; and means for performing, in connection with a determination that one or more intended slices include a high priority slice, at least one of cell selection or cell reselection based at least in part on the supported slice information.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of network slice assignment for a UE, in accordance with the present disclosure.

FIG. 4 is a diagram illustrating an example associated with UE slice-specific cell selection, in accordance with the present disclosure.

FIG. 5 is a diagram illustrating an example associated with UE slice-specific intra-frequency and/or equal priority inter-frequency cell selection, in accordance with the present disclosure.

FIGS. 6-11 are diagrams illustrating examples associated with UE slice-specific inter-frequency cell selection, in accordance with the present disclosure.

FIG. 12 is a diagram illustrating an example process associated with UE slice-specific cell selection and reselection, in accordance with the present disclosure.

FIG. 13 is a block diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

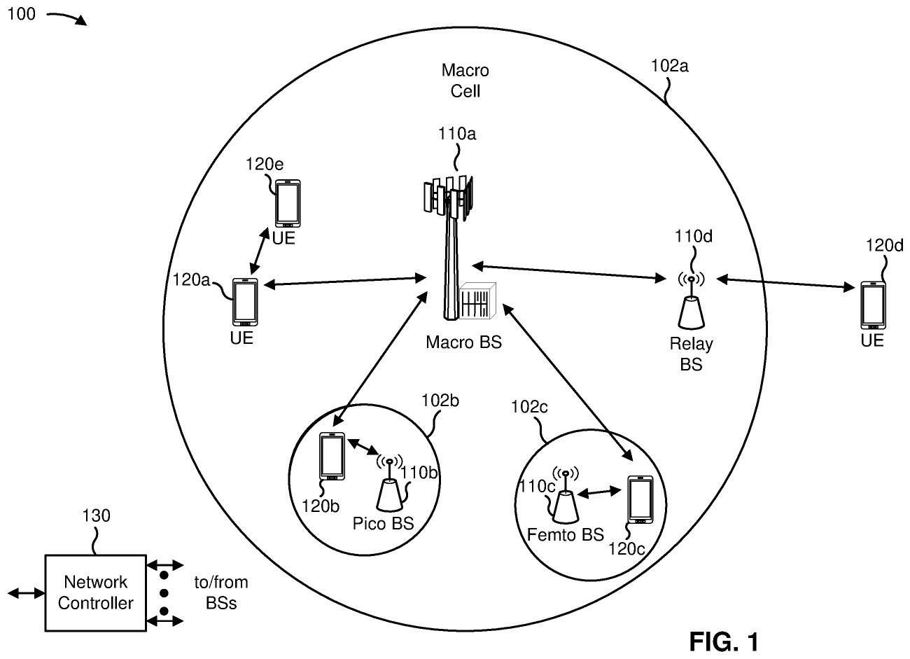

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

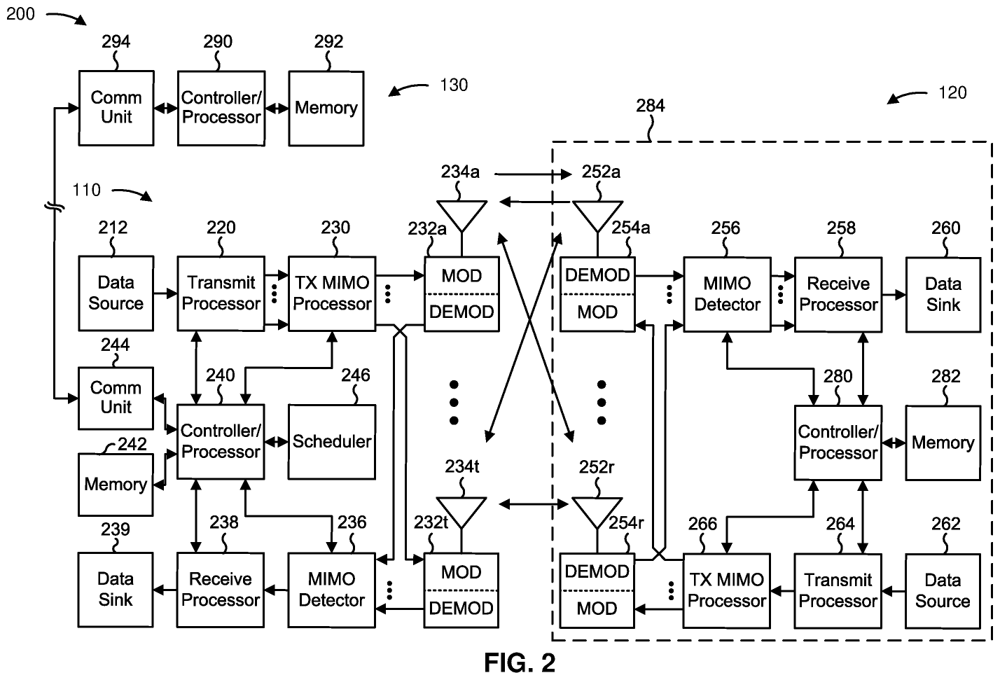

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

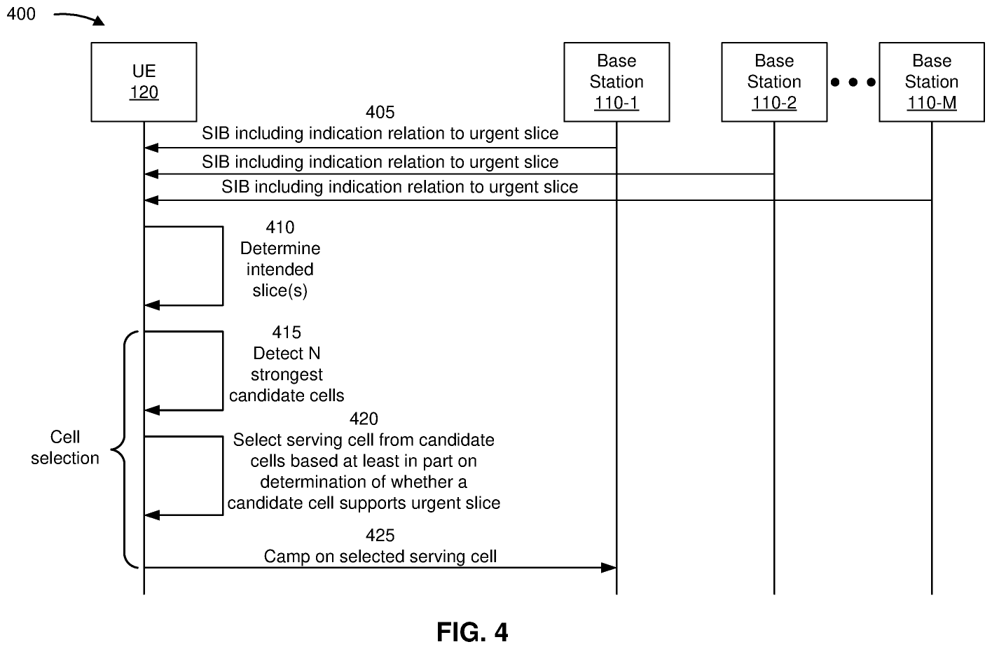

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 4-12).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 4-12).

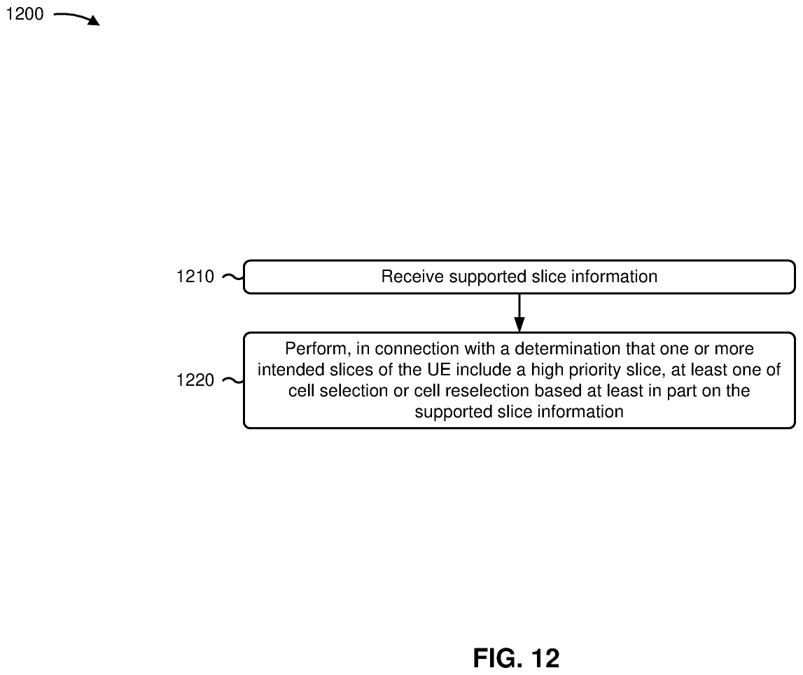

Controller/processor 240 of base station 110, controller/processor 280 of UE 120, and/or any other component(s) of FIG. 2 may perform one or more techniques associated with UE slice-specific cell selection and reselection, as described in more detail elsewhere herein. For example, controller/processor 240 of base station 110, controller/processor 280 of UE 120, and/or any other component(s) of FIG. 2 may perform or direct operations of, for example, process 1200 of FIG. 12, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1200 of FIG. 12, and/or other processes as described herein. In some aspects, executing instructions may include running the instructions, converting the instructions, compiling the instructions, and/or interpreting the instructions, among other examples.

In some aspects, the UE 120 includes means for receiving, from a base station, supported slice information; and/or means for performing, in connection with a determination that one or more intended slices for the UE include a high priority slice, at least one of cell selection or cell reselection based at least in part on the supported slice information. The means for the UE 120 to perform operations described herein may include, for example, one or more of antenna 252, demodulator 254, MIMO detector 256, receive processor 258, transmit processor 264, TX MIMO processor 266, modulator 254, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

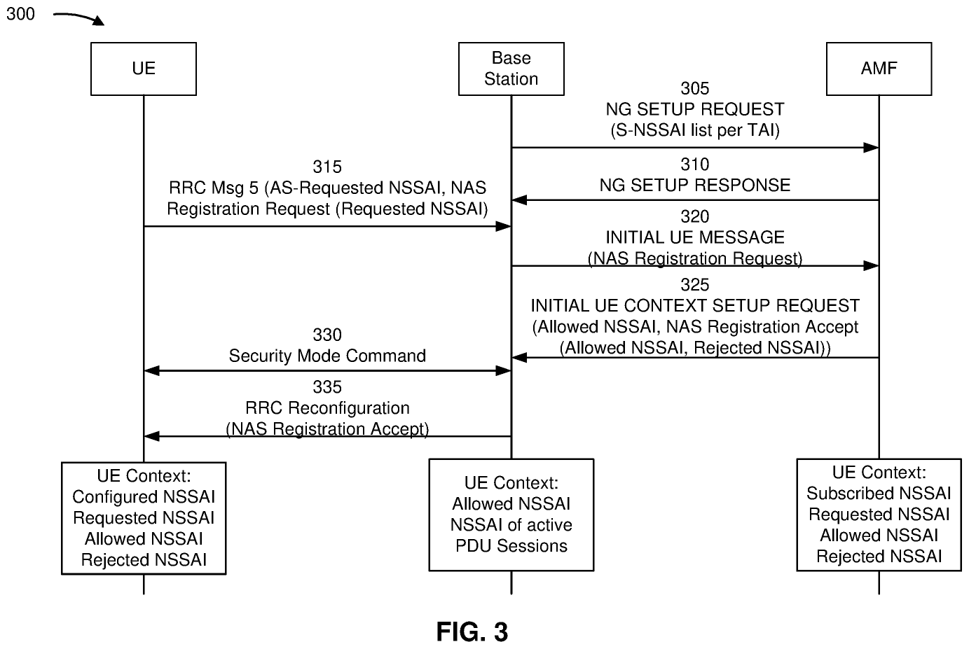

FIG. 3 is a diagram illustrating an example 300 of network slice assignment for a UE, in accordance with the present disclosure.

Network slicing involves implementing logical networks on top of a shared physical infrastructure, where each network slice may include an end-to-end connection of functions deployed for a particular application, application type, traffic type, or use case, among other examples. Each network slice may be identified by a network slice identity. A network slice identity may include a slice identifier referred to as a single-network slice selection assistance information (S-NSSAI). An S-NSSAI may indicate a slice service type (SST) using an SST value. For example, the SST value may indicate a network slicing type associated with enhanced mobile broadband (eMMB) communications, ultra-reliable low-latency communications (uRLLC), IoT communications, or V2X communications.

As shown in FIG. 3, network slices for a UE may be negotiated in a non-access stratum (NAS) registration procedure. As shown by reference number 305, during a 5G next generation (NG) setup procedure, a base station (e.g., gNB) may transmit, to an access and mobility management function (AMF) of a core network (e.g., 5G core network), an NG setup request message. The base station may include, in the NG setup request message, a list of S-NSSAIs supported by the base station. The list of S-NSSAIs may include supported S-NSSAIs per tracking area identity (TAI). Slice support (e.g., the supported S-NSSAIs) may be uniform within a tracking area. As shown by reference number 310, the AMF may transmit, to the base station, an NG setup response message. In some examples, the NG setup response message may include a list of S-NSSAIs supported by the AMF. For example, the list of S-NSSAIs supported by the AMF may include S-NSSAIs associated with network slicing instances in a public land mobile network (PLMN).

As further shown in FIG. 3, and by reference number 315, the UE may transmit, to the base station in a radio resource control (RRC) Msg5 message, an NAS registration request message including requested NSSAI. For example, the UE may transmit the RRC Msg5 message to the base station during a procedure to establish a protocol data unit (PDU) session. The requested network slice selection assistance information (NSSAI) may include an S-NSSAI or a list of multiple S-NSSAIs. In some examples, the UE may select the requesting NSSAI from configured NSSAI for the UE. The UE may also include, in the RRC Msg5 message, access stratum (AS)-requested NSSAI. The AS-requested NSSAI may be used by the base station to perform AMF select from multiple AMF instances in the core network. In some examples, the AS-requested NSSAI may be a subset of the requested NSSAI in the NAS registration request (for example, due to security concerns with the RRC Msg5 message).

As shown by reference number 320, the base station may transmit, to the AMF in the core network, an initial UE message that includes the NAS registration request message received from the UE. The AMF may determine allowed NSSAI for the UE from the requested NSSAI. For example, the AMF may validate the requested NSSAI based on subscribed NSSAI. The subscribed NSSAI may be a list of S-NSSAIs to which the UE is subscribed, and the AMF may compare each S-NSSAI in the requested NSSAI with the subscribed NSSAI to determine whether the UE is subscribed to that S-NSSAI. The AMF may determine whether the S-NSSAI(s) in the requested NSSAI are in the list of supported S-NSSAIs for the TAI in which the UE is located. The allowed NSSAI may include one or more S-NSSAIs in the requested NSSAI that are included in the subscribed NSSAI and in the list of supported S-NSSAIs supported for the TAI. In some examples, the allowed NSSAI may include default S-NSSAI(s) if no valid S-NSSAIs are requested. Rejected NSSAI includes S-NSSAI(s) in the rested NSSAI that are not included in the allowed NSSAI. As shown by reference number 325, the AMF may transmit, to the base station in an initial UE context setup request message, an NAS registration accept message that indicates the allowed NSSAI and the rejected NSSAI. The AMF may also include the allowed NSSAI in the initial UE context setup request message.

As shown in FIG. 3, and by reference number 330, the base station may transmit a security mode command message to the UE. The security mode command message is used to command the UE to activate AS security. As shown in reference number 335, the base station may transmit, to the UE in an RRC reconfiguration message, the NAS registration accept message that includes the accepted NSSAI and the rejected NSSAI. The PDU session established for the UE may be associated with a slice (e.g., identified by an S-NSSAI) in the allowed NSSAI. The UE may store UE context information including the configured NSSAI, the requested NSSAI, the allowed NSSAI, and the rejected NSSAI. The base station may store UE context information including the allowed NSSAI for the UE and NSSAI of active PDU sessions. The AMF may store UE context information including the subscribed NSSAI, the requested NSSAI, the allowed NSSAI, and the rejected NSSAI.

As indicated above, FIG. 3 is provided as an example. Other examples may differ from what is described with respect to FIG. 3.

In some examples, a UE in an RRC idle mode or an RRC inactive mode may perform cell selection to select a serving cell or may perform cell reselection to switch from a current serving cell to a neighboring serving cell. In this case, the UE may not consider network slicing during cell selection, and cell reselection may be only indirectly based on network slicing. For example, a base station may assign dedicated priorities to one or more configured cell frequencies in an RRC release message. In this case, the base station may assign a dedicated priority to a cell frequency based on an allowed NSSAI supported on the cell frequency, which may result in UE cell reselection based on the dedicated priority indirectly achieving slice-based cell reselection. However, in a case in which the UE intends to access a slice not in the allowed NSSAI, such indirect slice-based cell reselection does not help the UE to select a cell and/or frequency that supports the intended slice. Furthermore, the dedicated priority assigned in the RRC release message are released when a timer associated with cell reselection (e.g., a T320 timer) expires. Accordingly, a dedicated priority assigned based on an allowed NSSAI may no longer help the UE achieve slice-based cell reselection in a case in which the timer associated with cell reselection expires. In addition, different frequency priority configurations may be used for a specific slice in different geographical locations. This may result in a dedicated priority assigned to a frequency in an RRC release message when the UE is in one location to being incorrect in another location. For the at least the above described reasons, the indirect slice-based cell reselection may not reliably achieve slice-based cell selection and reselection for a UE. As a result, the UE may select a serving cell and/or serving frequency that does not support and intended slice of the UE. This may cause increased latency for traffic to and from the UE and may result in the UE not being able to satisfy quality of service (QoS) parameters associated with particular traffic types (e.g., uRLLC traffic).

Some techniques and apparatuses described herein enable UE to perform slice-specific cell selection and/or cell reselection. In some aspects, the UE may receive, from a base station, supported slice information. The UE, in connection with a determination that one or more intended slices of the UE include a high priority slice a high priority slice, may perform at least one of cell selection or cell reselection based at least in part on the supported slice information. As a result, the UE may select, in cell selection or cell reselection, a serving cell that supports the high priority slice included in the intended slices of the UE. This may result decreased latency for traffic to and from the UE and may result in the UE satisfying QoS parameters associated with particular traffic types (e.g., uRLLC traffic).

As used herein, “intended slice(s)” of a UE may mean one or more requested S-NSSAI(s) or one or more allowed S-NSSAI(s). In some aspects, for requesting new S-NSSAI(s) (e.g., for cell selection or initial registration), the intended slice(s) may be the requested S-NSSAI(s). In some aspects, for idle-mode mobility (e.g., cell reselection in RRC idle mode), the intended slice(s) may be the allowed S-NSSAI(s). In some aspects, for cell reselection in RRC inactive mode, the intended slice(s) may be S-NSSAI(s) associated with one or more activated PDU sessions with UE context that are suspended when the UE is in the RRC inactive mode.

FIG. 4 is a diagram illustrating an example 400 associated with UE slice-specific cell selection, in accordance with the present disclosure. As shown in FIG. 4, example 400 includes communication between one or more base stations 110 (e.g., base stations 110-1 to 110-M) and a UE 120. In some aspects, the base stations 110 and the UE 120 may be included in a wireless network, such as wireless network 100. The base stations 110 and the UE 120 may communicate via a wireless access link, which may include an uplink and a downlink. In some aspects, the M base stations 110-1, 110-2, . . . , 110-M may be associated with M respective cells (e.g., a first cell, a second cell, . . . , an M-th cell) from which the UE 120 may select a serving cell.

As shown in FIG. 4, and by reference number 405, the UE 120 may receive, from at least one base station 110, a system information block (SIB) that includes supported slice information for a serving cell associated with the base station 110. In some aspects, each of the base stations 110 may broadcast a respective SIB, and the UE 120 may receive the respective SIB broadcast from each base station. In some aspects, the SIB received from a base station 110 may include an indication relating to an urgent slice. For example, the indication may indicate whether the serving cell associated with the base station 110 supports an urgent slice.

In some aspects, the SIB may be a type 1 SIB (SIB 1), and the indication may be included in a bit field of the SIB 1. For example, the indication may be a 1-3 bit indication of whether the serving cell supports an urgent slice. In some aspects, which slice(s) is/are urgent slices may be defined in a wireless communication standard. For example, the urgent slice(s) may include one or more slices with an urgent latency QoS parameter and/or a particular slice type, such as a uRLLC slice. In some aspects, the indication may be a one bit indication, in the SIB 1, of whether the serving cell associated with the base station 110 that transmitted the SIB 1 supports the urgent slice. In some aspects, the indication may be a three bit indication, in the SIB 1, of an SST for the urgent slice supported by the serving cell associated with the base station 110 that transmitted the SIB 1. The one bit indication and/or the three bit indication, provide a benefit of including supported slice information relating to the urgent slice in SIB 1, which has a restricted payload size.

As further shown in FIG. 4, and by reference number 410, the UE 120 may determine one or more intended slices. In some aspects, for cell selection (e.g., initial cell selection and/or cell selection using stored frequency information), the intended slice(s) of the UE 120 may be one or more requested slices (e.g., requested S-NSSAI(s)) for the UE 120. For example, the UE 120 may determine the intended slice(s) by determining, prior to cell selection, one or more requested slices (e.g., requested S-NSSAI(s)) to be requested once the UE 120 registers on a selected cell.

In some aspects, the UE 120 may determine whether a high priority slice (e.g., an urgent slice) is included in the intended slice(s) of the UE 120. In some aspects, the high priority slice may be a slice with an urgent latency QoS parameter (e.g., an urgent latency requirement). For example, the high priority slice may be at least one uRLLC slice included in the intended slice(s) of the UE 120. In some aspects, in connection with a determination that the intended slice(s) of the UE 120 includes a high priority slice, the UE 120 may perform cell selection based at least in part on the supported slice information (e.g., the indications relating to the urgent slice) included in the SIB s received from the base stations 110.

As further shown in FIG. 4, and by reference number 415, the UE 120 may detect a number (N) of strongest candidate cells (e.g., candidate cells for cell selection) in each of a plurality of frequencies. For example, the UE 120 may search for N strongest candidate cells in each frequency, based at least in part on the determination that the intended slice(s) of the UE 120 includes a high priority slice. For example, N (e.g., the number of strongest candidate slices to search for) may be set according to a value in a wireless communication standard, or N may be configured via UE subscription. In some aspects, N may be greater than one, such that the UE 120 searches for multiple strongest candidate cells in each frequency.

In some aspects, for each frequency, the UE 120 may search for the N strongest candidate cells from the M available cells associated with base station 110-1 to 110-M. The UE 120 may determine the N strongest candidate cells for a frequency based at least in part on signal strength measurements (e.g., RSRP measurements) on the frequency for the M available cells. In some aspects, the UE 120 may search for the N strongest candidate cells from a highest priority PLMN for the UE 120. In this case, the UE 120 may prioritize selecting a cell in the highest priority PLMN over slice-based cell selection (e.g., if no cells in the highest priority PLMN support the urgent slice).

As further shown in FIG. 4, and by reference number 420, the UE 120 may select, as a serving cell, a candidate cell from the N strongest candidate cells in each frequency based at least in part on a determination of whether the candidate cell supports the urgent slice included in the intended slice(s) of the UE 120. In some aspects, for each of the N strongest candidate cells in each frequency, the UE 120 may determine whether the candidate cell is a suitable cell, and the UE 120 may determine, based at least in part on the indication included in the SIB for the candidate cell, whether the candidate cell supports the urgent slice included in the intended slice(s) of the UE 120.

A “suitable cell” is a cell that satisfies one or more suitability criteria (“S-criteria”) for cell selection. For example, the S-criteria may include a cell selection receive (Rx) level value (Srxlev), based at least in part on a measured RSRP value for the cell, and/or a cell selection quality value (Squal), based at least in part on a measured RSRQ value for the cell. In some aspects, a cell may be determined to be a suitable cell based at least in part on a determination that the Srxlev value for the cell satisfies a threshold (e.g., 0). In some aspects, a cell may be determined to be a suitable cell suitable cell based at least in part on a determination the Squal value for the cell satisfies a threshold (e.g., 0). In some aspects, a cell may be determined to be a suitable cell based at least in part on a determination Srxlev value for the cell satisfies a threshold (e.g., 0), and the Squal value for the cell satisfies a threshold (e.g., 0).

In some aspects, based at least in part on a determination that a candidate cell is a suitable cell that supports the urgent slice, the UE 120 may select that candidate cell as the serving cell. In some aspects, based at least in part on a determination that one or more candidate cells are suitable cells, but no suitable candidate cells support the urgent slice, the UE 120 may select, as the serving cell, one of the suitable candidate cells (e.g., a strongest of the suitable candidate cells) that does not support the urgent slice.

As further shown in FIG. 4, and by reference number 425, the UE 120 may camp on the selected serving cell on the frequency for which the serving cell was selected. For example, camping on the selected serving cell in an RRC idle mode or an RRC inactive mode may include registering with the selected serving cell. Once the UE 120 is camped on the serving cell, the UE 120 may monitor a control channel of the serving cell, receive system information, and/or perform cell reselection, among other examples.

As indicated above, FIG. 4 is provided as an example. Other examples may differ from what is described with respect to FIG. 4.

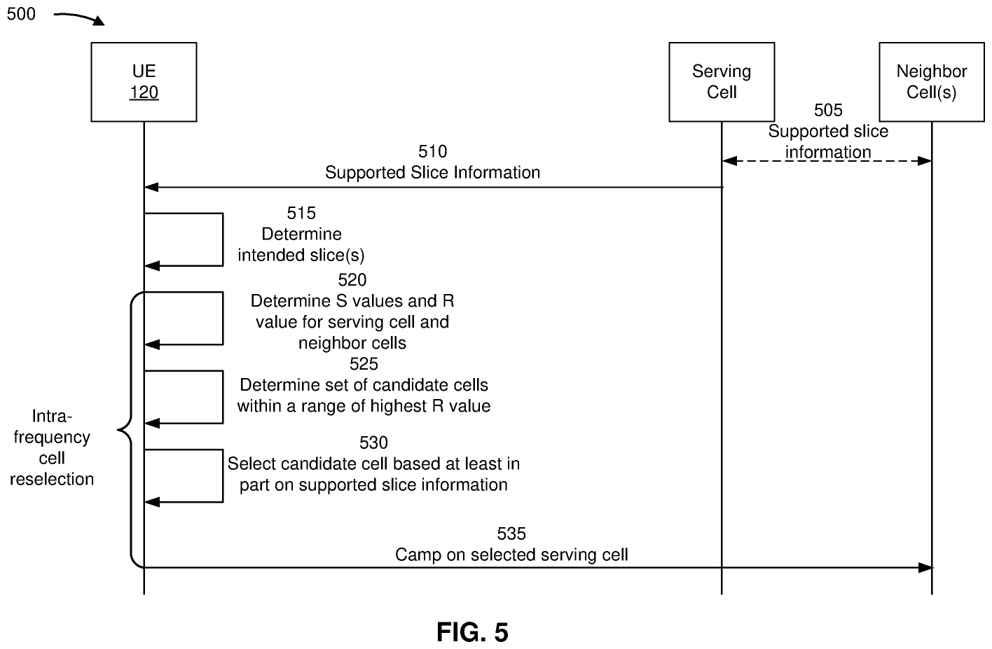

FIG. 5 is a diagram illustrating an example 500 associated with UE slice-specific intra-frequency and/or equal priority inter-frequency cell selection, in accordance with the present disclosure. As shown in FIG. 5, example 500 includes communication between a UE 120, a serving cell, and one or more neighbor cells. In some aspects, the UE 120 and base stations (e.g., base station 110) associated with the serving cell and the one or more neighbor cells may be included in a wireless network, such as wireless network 100. The UE 120 may communicate with the serving cell (e.g., with a base station associated with the serving cell) and/or each neighbor cell (e.g., a base station associated with each neighbor cell) via a wireless access link, which may include an uplink and a downlink.

As shown in FIG. 5, and by reference number 505, the serving cell and the one or more neighbor cells may exchange supported slice information via an interface (e.g., an Xn interface) between the base stations associated with the serving cell and the neighbor cells. In some aspects, the supported slice information may be exchanged between the serving cell and the neighbor cells via Xn signaling in Xn setup and/or configuration procedures. In some aspects, the supported slice information may be exchanged between the serving cell and the neighbor cells in an operations, administration, and maintenance (OAM) procedure.

In some aspects, the serving cell may receive, from the neighbor cells, supported slice information for the neighbor cells. For example, the supported slice information for a neighbor cell may identify supported slices in the neighbor cell. The supported slice information for the neighbor cell may also identify frequencies on which the supported slices are supported in the neighbor cells. In some aspects, the supported slice information for the neighbor cell may also include for each supported slice, per-slice frequency priority values for frequencies on which the supported slice is supported.

As further shown in FIG. 5, and by reference number 510, the UE 120 may receive, from the serving cell, supported slice information for the serving cell and the neighbor cells. In some aspects, the supported slice information may identify the slices supported in the serving cell and the slices supported in each of the one or more neighbor cells. The supported slice information may also identify frequencies on which the supported slices in the serving cell and the neighbor cells are supported. In some aspects, the supported slice information may also include for each supported slice, a respective per-slice frequency priority value for each frequency on which the supported slice is supported.

In some aspects, the serving cell may transmit the supported slice information to the UE 120 in an SIB. For example, the serving cell may transmit the supported slice information in a new SIB type (e.g., SIB 15), which may be on-demand broadcast by the serving cell (e.g., based at least in part on receiving a request from the UE 120). In some aspects, the serving cell may transmit the supported slice information in an RRC release message that causes the UE 120 to switch from an RRC connected mode to an RRC idle mode or an RRC inactive mode.

As further shown in FIG. 5, and by reference number 515, the UE 120 may determine one or more intended slices for the UE 120. In some aspects, for cell reselection (e.g., intra-frequency cell reselection and/or inter-frequency cell reselection) in an RRC idle mode and/or an RRC inactive mode, the intended slice(s) of the UE 120 may be one or more allowed slices (e.g., allowed S-NSSAI(s)) for the UE 120. In some aspects, for cell reselection in the RRC inactive mode, the intended slice(s) of the UE 120 may be one or more slices (e.g., S-NSSAI(s)) associated with one or more activated PDU sessions with UE context that are suspended when the UE is in the RRC inactive mode.

In some aspects, the UE 120 may determine whether a high priority slice (e.g., an urgent slice) is included in the intended slice(s) of the UE 120. In some aspects, the high priority slice may be a slice with an urgent latency QoS parameter (e.g., an urgent latency requirement). For example, the high priority slice may be at least one uRLLC slice included in the intended slice(s) of the UE 120. In some aspects, each slice in the one or more intended slices may have a respective slice priority value, and a high priority slice may correspond to a slice with a slice priority value that satisfies a threshold. In some aspects, the slice priorities may be determined by the UE 120. In some aspects, the slice priorities may be determined by a base station (e.g., a base station associated with the serving cell) based at least in part on highest allocation and retention priorities (ARPs) of QoS flows associated with the slices. In some aspects, in connection with a determination that the intended slice(s) of the UE 120 includes a high priority slice, the UE 120 may perform intra-frequency cell reselection based at least in part on the supported slice information.

As further shown in FIG. 5, and by reference number 520, the UE 120 may determine S-criteria values (“S values”) and a ranking criterion (“R-criterion”) value (“R value” or “ranking value”) for the serving cell and the neighbor cells. In some aspects, the S values, determined by the UE 120 for each cell, may include the Srxlev value and/or the Squal value. For example, the UE 120 may determine the Srxlev value for a cell as: Srxlev=Qrxlevmeas−(Qrxlevmin+Qrxlevminoffset)−Pcompensation−Qoffsettemp, where Qrxlevmeas is a measured RSRP value for the cell, Qrxlevmin is a minimum RSRP value for the cell, Qrxlevminoffset is an offset to the signaled Qrxlevmin, Pcompensation is a power compensation value, and Qoffsettemp is a temporary offset. The UE 120 may determine the Squal for a cell as: Qqualmeas−(Qqualmin+Qqualminoffset)−Qoffsettemp, where Qqualmeas is a measured RSRQ value for the cell, Qqualmin is a minimum RSRQ value for the cell, and Qqualminoffset is an offset to the signaled Qqualmin. The UE 120 may determine the S values without considering the supported slice information.

In some aspects, UE 120 may determine, from a plurality of cells including the serving cell and the one or more neighbor cells, a set of suitable cells. The UE 120 may determine whether a cell is a suitable cell based on the Srxlev value and/or the Squal value for the cell. For example, the UE 120 may determine that a cell is a suitable cell based at least in part on a determination that the Srxlev value for the cell satisfies an Srxlev threshold (e.g., 0) and/or based at least in part on a determination that the Squal value for the cell satisfies an Squal threshold (e.g., 0).

In some aspects, the UE 120 may determine the R value the serving cell and each of the neighbor cells in the set of suitable sells. The UE 120 may determine the R value for the serving cell (Rs) as: Rs=Qmeas,s+Qhyst−Qoffsettemp, where Qmeas,s is the measured RSRP value in the serving cell, and Qhyst is a hysteresis value for the ranking criterion. The UE 120 may determine the R value (Rn) for each neighbor cell in the set of suitable cells as: Rn=Qmeas,n−Qoffset−Qoffsettemp, where Qmeas,n is the measure RSRP value for the neighbor cell and Qoffset is a specified offset between the serving cell and the neighbor cell (and/or a specified offset between frequencies. For each cell in the set of suitable cells, the R value determined for the cell may be a ranking value for the cell. In some aspects, the UE 120 may determine the ranking values for the cells in the set of suitable cells without considering the supported slice information.

As further shown in FIG. 5, and by reference number 525, the UE 120 may determine a set of candidate cells within a range of a highest R value. The UE 120 may identify a highest ranking value for a cell in the set of suitable cells. The UE 120 may determine, from the set of suitable cells, the set of candidate cells with respective ranking values that are within a range of the highest ranking value. In some aspects, the range (e.g., rangeToBestCellSlice) may be configured in an SIB received from the serving cell. In some aspects, UE 120 may determine, from the set of candidate cells within a ranking range, a set of candidate cells with a highest number of beams.

As further shown in FIG. 5, and by reference number 530, the UE 120 may select, as a serving cell, a candidate cell, from the set of candidate cells, based at least in part on the supported slice information. By selecting the serving cell from the set of candidate cells with ranking values within the range of the highest ranking value, the UE 120 may achieve a benefit of preventing a loss of coverage for the UE 120 dues to slice prioritization. In some aspects, based at least in part on the supported slice information, the UE 120 may select, from the set of candidate cells (e.g., suitable cells within ranking values within the range of the highest ranking value), a candidate cell that supports a highest priority slice in the intended slice(s) for the UE 120. In a case in which the UE 120 identifies multiple candidate cells that support the highest priority slice in the intended slice(s) for the UE 120, the UE 120 may select a candidate cell having the largest R value (ranking value) from the multiple candidate cells that support the highest priority slice in the intended slice(s) for the UE 120.

In some aspects, based at least in part on the supported slice information, the UE 120 may select, from the set of candidate cells, a candidate cell that supports all of the intended slice(s) for the UE 120. In a case in which the UE 120 identifies multiple candidate cells that support all of the intended slice(s) for the UE 120, the UE 120 may select a candidate cell having the largest R value (ranking value) from the multiple candidate cells that support all of the intended slice(s) for the UE 120.

As further shown in FIG. 5, and by reference number 535, the UE 120 may camp on the selected serving cell (e.g., the selected candidate cell).

As indicated above, FIG. 5 is provided as an example. Other examples may differ from what is described with respect to FIG. 5.

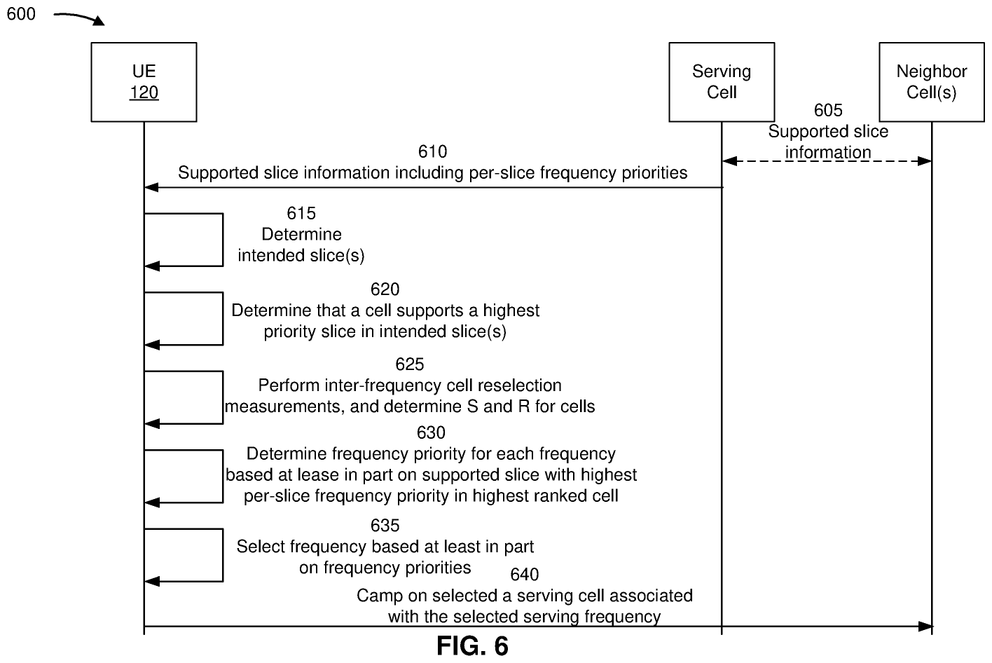

FIG. 6 is a diagram illustrating an example 600 associated with UE slice-specific inter-frequency cell selection, in accordance with the present disclosure. As shown in FIG. 6, example 600 includes communication between a UE 120, a serving cell, and one or more neighbor cells. In some aspects, the UE 120 and base stations (e.g., base station 110) associated with the serving cell and the one or more neighbor cells may be included in a wireless network, such as wireless network 100. The UE 120 may communicate with the serving cell (e.g., with a base station associated with the serving cell) and/or each neighbor cell (e.g., a base station associated with each neighbor cell) via a wireless access link, which may include an uplink and a downlink.

As shown in FIG. 6, and by reference number 605, the serving cell and the one or more neighbor cells may exchange supported slice information via an interface (e.g., the Xn interface) between the base stations associated with the serving cell and the neighbor cells. In some aspects, the supported slice information may be exchanged between the serving cell and the neighbor cells via Xn signaling in Xn setup and/or configuration procedures. In some aspects, the supported slice information may be exchanged between the serving cell and the neighbor cells in an OAM procedure.

In some aspects, the serving cell may receive, from the neighbor cells, supported slice information for the neighbor cells. For example, the supported slice information for a neighbor cell may identify supported slices in the neighbor cell. The supported slice information for the neighbor cell may also identify frequencies on which the supported slices are supported in the neighbor cells. In some aspects, the supported slice information for the neighbor cell may also include for each supported slice, per-slice frequency priority values for frequencies on which the supported slice is supported.

As further shown in FIG. 6, and by reference number 610, the UE 120 may receive, from the serving cell, supported slice information for the neighbor cells. In some aspects, the supported slice information for the neighbor cells may identify supported slices in the neighbor cells, and the supported slice information may identify per-slice frequency priorities for frequencies associated with each supported slice in the neighbor cells (e.g., frequencies on which each supported slice are supported). For example, the supported slice information may include slice identifiers (slice IDs) that identify supported slices in the neighbor cells and one or more per-slice frequency priority values for each slice ID (e.g., for one or more frequencies associated with each slice ID). In some aspects, the per-slice frequency priority values may have a range of 0-7 (e.g., corresponding to priority 1-priority 8).

In some aspects, the supported slice information may include a list of frequencies, and, for each frequency in the list of frequencies: a list of slice IDs associated with the frequency, a per-slice frequency priority value for the frequency for each slice ID in the list of slice IDs, and a list of physical cell IDs (PCIs) identifying, for each slice ID in the list of slice IDs, one or more cells (e.g., neighbor cells) that support a corresponding slice on the frequency. For example, a signaling format for the supported slice information (e.g., in an SIB or an RRC release message) may include a list of {frequency, list of [Slice ID, per-slice frequency priority value, list of PCIs]}.

In some aspects, the supported slice information may include a list of the slice IDs, and, for each slice ID in the list of slice IDs, a list of frequencies associated with the slice identifier, a per-slice frequency priority value for each frequency in the list of frequencies for the slice ID, and a list of PCIs identifying, for each frequency in the list of frequencies, one or more cells (e.g., neighbor cells) that support the slice ID on that frequency. For example, a signaling format for the supported slice information (e.g., in an SIB or an RRC release message) may include a list of {slice ID, list of [frequency, per-slice frequency priority value, list of PCIs]}.

In some aspects, the slice ID may be an S-NSSAI, an SST indication, or a slice index that is mapped to a corresponding S-NSSAI. In some aspects, the slice ID may be a slice group ID associated with a group of slices. For example, a mapping may be configured that maps sets of S-NSSAIs to slice groups having corresponding slice group IDs. In this case, a slice group ID may be used to indicate a set of supported slices on a frequency in a cell. This may provide a benefit of reducing payload size for transmitting the supported slice information (e.g., in an SIB or an RRC release message).

In some aspects, the serving cell may transmit the supported slice information (e.g., including the slice IDs, for each frequency, and the per-slice frequency priority values for each slice ID) in an SIB. For example, the serving cell may transmit the supported slice information in a new SIB type (e.g., SIB 15), which may be on-demand broadcast by the serving cell (e.g., based at least in part on receiving a request from the UE 120). This may provide a benefit of reducing a payload size of other broadcast SIB s (e.g., SIB 1). In some aspects, receiving, by the UE 120, the per-slice frequency values for each slice identifier in the SIB may overwrite per-cell frequency priority values received in the SIB or in another SIB transmitted by the serving cell. For example, the UE 120 based at least in part on receiving per-slice frequency priority values in the SIB may ignore per-cell frequency priority values transmitted by the serving cell in the SIB or another SIB.

In some aspects, the serving cell may transmit the supported slice information (e.g., including the slice IDs, for each frequency, and the per-slice frequency priority values for each slice ID) in an RRC release message. For example, the serving cell may transmit the supported slice information to the UE 120 in an RRC release message that causes the UE 120 to switch from an RRC connected mode to an RRC idle mode or an RRC inactive mode. In some aspects, receiving, by the UE 120, the per-slice frequency values for each slice identifier in the RRC release message may overwrite frequency priority values received in an SIB transmitted by the serving cell. For example, the UE 120, based at least in part on receiving the per-slice frequency priority values (or a UE-specific frequency priority value) may ignore per-cell frequency priority values transmitted by the serving cell in an SIB. In some aspects, in a case in which the RRC release message includes the per-slice frequency values, the RRC release message may not include a UE-specific frequency priority. In some aspects, RRC dedicated signaling of the supported slice information (e.g., in the RRC release message) may provide benefits of increased support for radio access network (RAN) sharing and/or faster update speed, as compared to transmitting the slice information in an SIB. In some aspects, dedicated RRC signal of the supported slice information may be used to provide security protection, for example, for sensitive supported slice information.

As further shown in FIG. 6, and by reference number 615, the UE 120 may determine one or more intended slices for the UE 120. In some aspects, for cell reselection (e.g., intra-frequency cell reselection and/or inter-frequency cell reselection) in an RRC idle mode and/or an RRC inactive mode, the intended slice(s) of the UE 120 may be one or more allowed slices (e.g., allowed S-NSSAI(s)) for the UE 120. In some aspects, for cell reselection in the RRC inactive mode, the intended slice(s) of the UE 120 may be one or more slices (e.g., S-NSSAI(s)) associated with one or more activated PDU sessions with UE context that are suspended when the UE is in the RRC inactive mode.

In some aspects, the UE 120 may determine whether a high priority slice (e.g., an urgent slice) is included in the intended slice(s) of the UE 120. In some aspects, the high priority slice may be a slice with an urgent latency QoS parameter (e.g., an urgent latency requirement). For example, the high priority slice may be at least one uRLLC slice included in the intended slice(s) of the UE 120. In some aspects, each slice in the one or more intended slices may have a respective slice priority value, and a high priority slice may correspond to a slice with a slice priority value that satisfies a threshold. In some aspects, the slice priorities may be determined by the UE 120. In some aspects, the slice priorities may be determined by a base station (e.g., a base station associated with the serving cell) based at least in part on highest ARPs of QoS flows associated with the slices. In some aspects, in connection with a determination that the intended slice(s) of the UE 120 includes a high priority slice, the UE 120 may perform inter-frequency cell reselection based at least in part on the supported slice information.

As further shown in FIG. 6, and by reference number 620, the UE 120 may determine, for a non-serving frequency (e.g., neighbor frequency), that at least one cell supports a highest priority slice in the intended slice(s) for the UE 120. For example, UE 120 may determine, for a configured frequency, whether any cell supports the highest priority slice in the intended slice(s) for the UE 120 on that frequency. In some aspects, the UE 120 may determine that at least one cell supports a highest priority slice in the intended slice(s) for the UE 120 for multiple frequencies.

As further shown in FIG. 6, and by reference number 625, based at least in part on the determination, for each of one or more frequencies, that the a cell (e.g., a neighbor cell) supports the highest priority slice in the intended slice(s) for the UE 120, the UE 120 may perform inter-frequency cell reselection measurements for all cells (e.g., neighbor cells and the serving cell) in each of the one or more frequencies, and the UE 120 may determine the S values and the R value for the cells. In some aspects, the determination that a cell provides the highest priority slice in the intended slice(s) may trigger the UE 120 to perform the cell reselection measurements for that frequency irrespective of whether the Srxlev value and the Squal value for serving frequency satisfy respective thresholds (e.g., S_{nonIntraSearchP} and S_{nonIntraSearchQ}) associated with not performing cell reselection measurements.

In some aspects, the inter-frequency cell reselection measurements for the cells may include RSRP measurements and/or RSRQ measurements. The UE 120 may determine the S values (e.g., Srxlevl and/or Squal) for the cells based at least in part on the RSRP and RSRQ measurements, for example, as described above in connection with FIG. 5. The UE 120 may determine suitable cells based at least in part on the S values, and the UE 120 may determine ranking values (e.g., R values) for the suitable cells, for example, as described above in connection with FIG. 5. In some aspects, the UE 120 may determine ranks from the suitable cells based at least in part on the ranking values determined for the suitable cells. In some aspects, the UE 120 may determine the ranks for the cells by ranking the cells by the ranking values determined for the cells. In this case, the UE 120 may rank the cells using the ranking values without considering the supported slice information. In some aspects, the UE 120 may identify cells with ranking values within a range of the highest ranking value determined for a cell. In this case, the UE 120 may determine that all cells with ranking values within the range of the highest ranking value have a same rank, or the UE 120 may determine ranks for the cells with ranking values within the range of the highest ranking value based at least in part on a determination of whether the cells support the highest priority slice in the intended slice(s).

As further shown in FIG. 6, and by reference number 630, the UE 120 may determine, for each frequency of a plurality of configured frequencies, a respective frequency priority based at least in part on a supported slice with a highest per-slice frequency priority in a highest ranked cell for that frequency. In some aspects, the UE 120 may determine, for a frequency, the highest ranked cell for the frequency based at least in part on the ranks for the cells in that frequency. The UE 120 may determine, based at least in part on the supported slice information, the supported slice with the highest per-slice frequency priority, for the frequency, in the highest ranked cell for the frequency. The UE 120 may determine that the frequency priority for the frequency is equal to the per-slice frequency priority value of the supported slice with the highest per-slice frequency priority in the highest ranked supported cell for the frequency.

In some aspects, the UE 120 may determine a frequency priority of the serving frequency based at least in part on the supported slices in the serving cell. In some aspects, the UE 120 may determine a highest value frequency priority for the current serving frequency based at least in part on a determination that the serving cell supports all of intended slices for the UE 120. In some aspects, the UE 120 may determine a highest value frequency priority for the current serving frequency based at least in part on a determination that the serving cell supports a highest priority slice included in the one or more intended slices for the UE 120.

As further shown in FIG. 6, and by reference number 635, the UE 120 may select a serving frequency, from the plurality of configured frequencies, based at least in part on the respective frequency priority determined for each frequency of the plurality of configured frequencies. In some aspects, the UE 120 may identify a neighbor frequency (e.g., non-serving frequency) with a highest frequency priority, and the UE 120 may compare the frequency priority for the neighbor frequency with a frequency priority of the current serving frequency. The UE 120 may select to switch to the neighbor frequency with the highest frequency priority or remain on the current serving frequency based at least in part on the comparison. For example, in a case in which the neighbor frequency has a higher frequency priority than the current frequency, the UE 120 may select the neighbor frequency as the serving frequency based at least in part on a determination that the Srxlev value satisfies a threshold associated with switching to a higher priority frequency. In a case in which the current serving frequency has a higher frequency priority than the neighbor frequency (e.g., due to the current cell supporting the highest priority slice in the intended slice(s) or all of the intended slice(s)), UE 120 may select the neighbor frequency based at least in part on a determination that the Srxlev value of the serving frequency does not satisfy a threshold associated with switching to a lower priority frequency, and the Srxlev value of neighbor frequency does satisfy the threshold associated with switching to a lower priority frequency.

As further shown in FIG. 6, and by reference number 640, the UE 120 may camp on a serving cell associated with the selected serving frequency.

As indicated above, FIG. 6 is provided as an example. Other examples may differ from what is described with respect to FIG. 6.

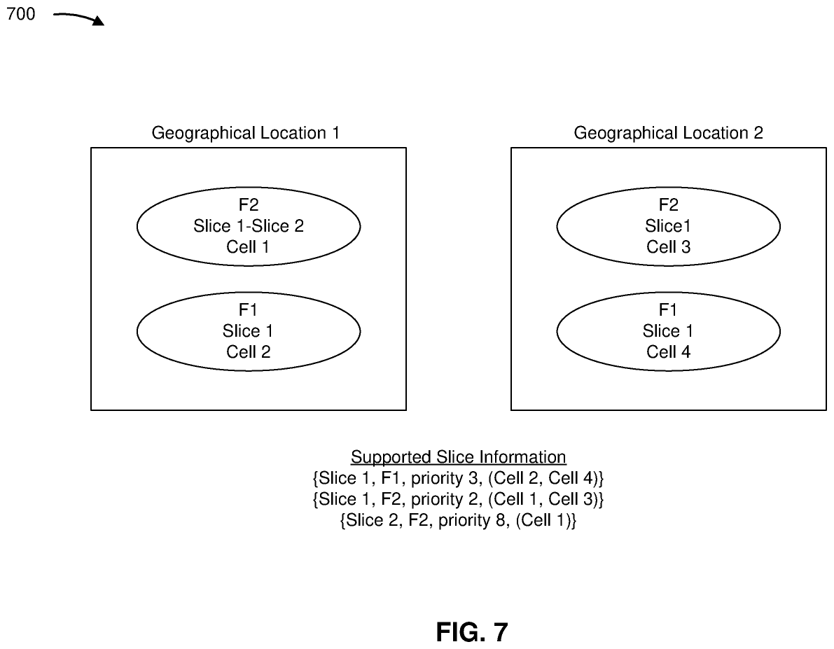

FIG. 7 is a diagram illustrating an example 700 associated with UE slice-specific inter-frequency cell selection, in accordance with the present disclosure. As shown in FIG. 7, example 700 shows an example of inter-frequency cell reselection based at least in part on per-slice frequency priority values, as described above in connection with FIG. 6.

As shown in FIG. 7, a UE 120 may receive (e.g., in an SIB or an RRC release message) supported slice information including per-slice frequency priority values. For example, the supported slice information may include: {Slice 1, F1, priority 3, (Cell 2, Cell 4)}; {Slice 1, F2, priority 2, (Cell 1, Cell 3)}; and {Slice 2; F2, priority 8, (Cell 1)}. In this case, Slice 1 is supported on a first frequency (F1) on a Cell 2 and Cell 4, and the per-slice frequency priority value for F1 and Slice 1 is 3. Slice 1 is supported on a second frequency (F2) on Cell 1 and Cell 3, and the per-slice frequency priority value for F1 and Slice 1 is 2. Slice 2 is supported on F2 in Cell 1, and the per-slice frequency priority value for F2 and Slice 2 is 8.

In example 700, Slice 1 may be an eMBB slice, Slice 2 may be a uRLLC slice, F1 may be 2.6 GHz, and F2 may be 4.9 GHz. In this case, in location 1, the slice-specific frequency priority for F1 may be greater than the slice-specific frequency priority for F2 for the eMBB slice, and the slice-specific frequency priority for F2 may be greater than the slice-specific frequency priority for F1 for the uRLLC slice (e.g., because F2 may be primarily used to provide uRLLC service).

In some aspects, the UE 120 may support both eMBB (Slice 1) and uRLLC (Slice 2). In this case, the intended slices for the UE 120 may include Slice 1 and Slice 2, and Slice 2 may have a higher slice priority than Slice 1 (e.g., Slice 2 may be the highest priority slice in the intended slices). For inter-frequency cell reselection in geographical location 1, the UE 120 may determine that a highest ranked cell for F1 is Cell 2. For Cell 2, the supported slice having the highest per-slice frequency priority value is Slice 1, with a per-slice frequency priority value of 3. Accordingly, the UE 120 may determine that a frequency priority of 3 for F1. The UE 120 may determine that a highest ranked cell for F2 is Cell 1. For Cell 1, the supported slice having the highest per-slice frequency value is Slice 2, with a per-slice frequency priority of 8. Accordingly, the UE 120 may determine a frequency priority value of 8 for F2. In location 1, the UE 120 may select F2 over F1 based at least in part on a determination the frequency priority of F2 (e.g., 8) is greater than the frequency priority of F1 (e.g., 3).

For inter-frequency cell reselection in geographical location 2, the UE 120 may determine that a highest ranked cell for F1 is Cell 4. For Cell 4, the supported slice having the highest per-slice frequency priority value is Slice 1, with a per-slice frequency priority value of 3. Accordingly, the UE 120 may determine that a frequency priority of 3 for F1. The UE 120 may determine that a highest ranked cell for F2 is Cell 3. For Cell 3, the supported slice having the highest per-slice frequency value is Slice 1, with a per-slice frequency priority of 2. Accordingly, the UE 120 may determine a frequency priority value of 2 for F2. In location 2, the UE 120 may select F1 over F2 based at least in part on a determination the frequency priority of F1 (e.g., 3) is greater than the frequency priority of F2 (e.g., 2).

In some aspects, the configuration for the slice-specific frequency priority change based at least in part on the location of the UE 120. For example, when the UE 120 moves from location 1 to location 2, the frequency priority for eMBB (Slice 1) may change such that the frequency priority for F2 may be greater than the frequency priority for F1 for the eMBB slice (e.g., because F2, with a wider frequency band may be deployed as a eMBB hotspot in location 2). Accordingly, the slice-specific frequency priorities may also be area-specific frequency priorities. For example, the configuration of the supported slice information at location 2 may change, from the supported slice information shown in FIG. 7, to {Slice 1, F1, priority 3 (Cell 2, Cell 4)}; and {Slice 1, F2, priority 4 (Cell 1, Cell 3)}. In this case, for inter-frequency cell reselection in geographical location 2, the UE 120 may determine that the frequency priority value for F1 is 3 based at least on the per-slice frequency priority value of Slice 1 (e.g., the supported slice having the highest per-slice frequency value) in Cell 4 (e.g., the highest ranked cell for F1). The UE 120 may determine that the frequency priority value for F2 is 4 based at least in part on the (area-specific) per-slice frequency priority value of Slice 1 (e.g., the supported slice having the highest per-slice frequency value) in Cell 3 (e.g., the highest ranked cell for F2). In this case, the UE may select F2 over F1 in location 2.

As indicated above, FIG. 7 is provided as an example. Other examples may differ from what is described with respect to FIG. 7.

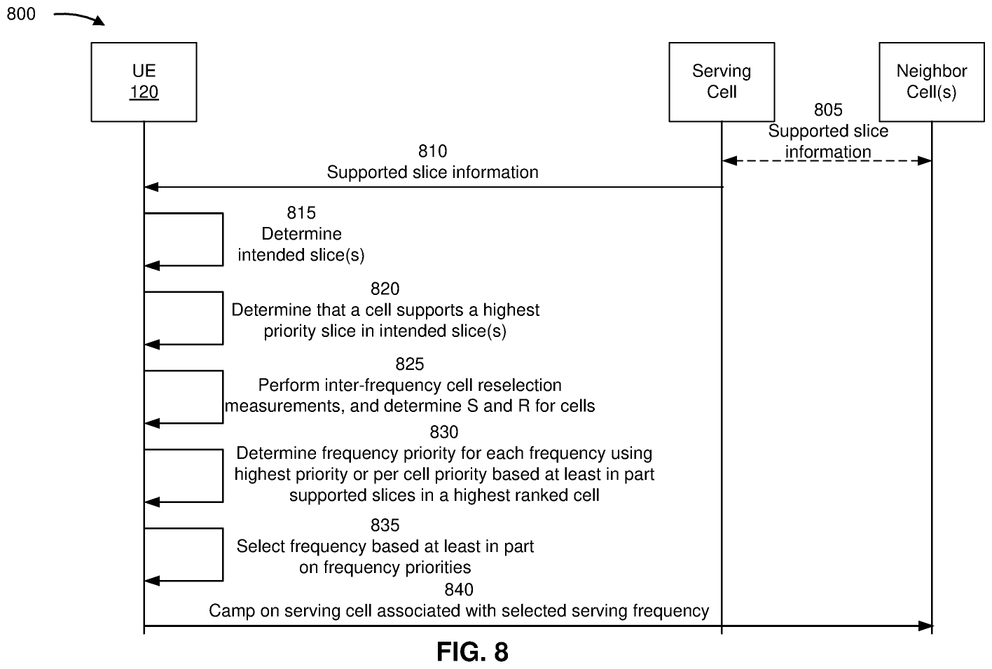

FIG. 8 is a diagram illustrating an example 800 associated with UE slice-specific inter-frequency cell selection, in accordance with the present disclosure. As shown in FIG. 8, example 800 includes communication between a UE 120, a serving cell, and one or more neighbor cells. In some aspects, the UE 120 and base stations (e.g., base station 110) associated with the serving cell and the one or more neighbor cells may be included in a wireless network, such as wireless network 100. The UE 120 may communicate with the serving cell (e.g., with a base station associated with the serving cell) and/or each neighbor cell (e.g., a base station associated with each neighbor cell) via a wireless access link, which may include an uplink and a downlink.

As shown in FIG. 8, and by reference number 805, the serving cell and the one or more neighbor cells may exchange supported slice information via an interface (e.g., the Xn interface) between the base stations associated with the serving cell and the neighbor cells. In some aspects, the supported slice information may be exchanged between the serving cell and the neighbor cells via Xn signaling in Xn setup and/or configuration procedures. In some aspects, the supported slice information may be exchanged between the serving cell and the neighbor cells in an OAM procedure.

In some aspects, the serving cell may receive, from the neighbor cells, supported slice information for the neighbor cells. For example, the supported slice information for a neighbor cell may identify supported slices in the neighbor cell. The supported slice information for the neighbor cell may also identify frequencies on which the supported slices are supported in the neighbor cells.

As further shown in FIG. 8, and by reference number 810, the UE 120 may receive, from the serving cell, supported slice information for the neighbor cells. In some aspects, the supported slice information for the neighbor cells may identify supported slices in the neighbor cells. For example, the supported slice information may include slice IDs that identify supported slices in the neighbor cells.

In some aspects, the supported slice information may include a list of frequencies, and, for each frequency in the list of frequencies: a list of slice IDs associated with the frequency, and a list of PCIs for each slice ID. For example, a signaling format for the supported slice information (e.g., in an SIB or an RRC release message) may include a list of {frequency, list of [Slice ID, list of PCIs] }.

In some aspects, the supported slice information may include a list of frequencies, and, for each frequency in the list of frequencies: a list of PCIs associated with the frequency and a list of slice IDs for each slice PCI. For example, a signaling format for the supported slice information (e.g., in an SIB or an RRC release message) may include a list of {frequency, list of [PCI, list of Slice IDs]}.

In some aspects, the supported slice information may include a list of slice IDs, and, for each slice ID in the list of slice IDs: a frequency associated with the slice ID, and a list of PCIs for each frequency. For example, a signaling format for the supported slice information (e.g., in an SIB or an RRC release message) may include a list of {slice ID, list of [frequency, list of PCIs] }.

In some aspects, the slice ID may be an S-NSSAI, an SST indication, or a slice index that is mapped to a corresponding S-NSSAI. In some aspects, the slice ID may be a slice group ID associated with a group of slices. For example, a mapping may be configured that maps sets of N-SSAIs to slice groups having corresponding slice group IDs. In this case, a slice group ID may be used to indicate a set of supported slices on a frequency in a cell. This may provide a benefit of reducing payload size for transmitting the supported slice information (e.g., in an SIB or an RRC release message).

In some aspects, the serving cell may transmit the supported slice information (e.g., including the slice IDs, for each frequency, and the per-slice frequency priority values for each slice ID) in an SIB. For example, the serving cell may transmit the supported slice information in a new SIB type (e.g., SIB 15), which may be on-demand broadcast by the serving cell (e.g., based at least in part on receiving a request from the UE 120). This may provide a benefit of reducing a payload size of other broadcast SIB s (e.g., SIB 1).

In some aspects, the serving cell may transmit the supported slice information (e.g., including the slice IDs, for each frequency, and the per-slice frequency priority values for each slice ID) in an RRC release message. For example, the serving cell may transmit the supported slice information to the UE 120 in an RRC release message that causes the UE 120 to switch from an RRC connected mode to an RRC idle mode or an RRC inactive mode. In some aspects, RRC dedicated signaling of the supported slice information (e.g., in the RRC release message) may provide benefits of increase support for RAN sharing and/or faster update speed, as compared to transmitting the slice information in an SIB. In some aspects, dedicated RRC signal of the supported slice information may be used to provide security protection, for example, for sensitive supported slice information.

As further shown in FIG. 8, and by reference number 815, the UE 120 may determine one or more intended slices for the UE 120. In some aspects, for cell reselection (e.g., intra-frequency cell reselection and/or inter-frequency cell reselection) in an RRC idle mode and/or an RRC inactive mode, the intended slice(s) of the UE 120 may be one or more allowed slices (e.g., allowed S-NSSAI(s)) for the UE 120. In some aspects, for cell reselection in the RRC inactive mode, the intended slice(s) of the UE 120 may be one or more slices (e.g., S-NSSAI(s)) associated with one or more activated PDU sessions with UE context that are suspended when the UE is in the RRC inactive mode.

In some aspects, the UE 120 may determine whether a high priority slice (e.g., an urgent slice) is included in the intended slice(s) of the UE 120. In some aspects, the high priority slice may be a slice with an urgent latency QoS parameter (e.g., an urgent latency requirement). For example, the high priority slice may be at least one uRLLC slice included in the intended slice(s) of the UE 120. In some aspects, each slice in the one or more intended slices may have a respective slice priority value, and a high priority slice may correspond to a slice with a slice priority value that satisfies a threshold. In some aspects, the slice priorities may be determined by the UE 120. In some aspects, the slice priorities may be determined by a base station (e.g., a base station associated with the serving cell) based at least in part on highest ARPs of QoS flows associated with the slices. In some aspects, in connection with a determination that the intended slice(s) of the UE 120 includes a high priority slice, the UE 120 may perform inter-frequency cell reselection based at least in part on the supported slice information.

As further shown in FIG. 8, and by reference number 820, the UE 120 may determine, for a non-serving frequency (e.g., neighbor frequency), that at least one cell supports a highest priority slice in the intended slice(s) for the UE 120. For example, UE 120 may determine, for a configured frequency, whether any cell supports the highest priority slice in the intended slice(s) for the UE 120 on that frequency. In some aspects, the UE 120 may determine that at least one cell supports a highest priority slice in the intended slice(s) for the UE 120 for multiple frequencies.

As further shown in FIG. 8, and by reference number 825, based at least in part on the determination, for each of one or more frequencies, that the a cell (e.g., a neighbor cell) supports the highest priority slice in the intended slice(s) for the UE 120, the UE 120 may perform inter-frequency cell reselection measurements for all cells (e.g., neighbor cells and the serving cell) in each of the one or more frequencies, and the UE 120 may determine the S values and the R value for the cells. In some aspects, the determination that a cell provides the highest priority slice in the intended slice(s) may trigger the UE 120 to perform the cell reselection measurements for that frequency irrespective of whether the Srxlev value and the Squal value for serving frequency satisfy respective thresholds (e.g., S_{nonIntraSearchP} and S_{nonIntraSearchQ}) associated with not perform cell reselection measurements.

In some aspects, the inter-frequency cell reselection measurements for the cells may include RSRP measurements and/or RSRQ measurements. The UE 120 may determine the S values (e.g., Srxlevl and/or Squal) for the cells based at least in part on the RSRP and RSRQ measurements, for example, as described above in connection with FIG. 5. The UE 120 may determine suitable cells based at least in part on the S values, and the UE 120 may determine ranking values (e.g., R values) for the suitable cells, for example, as described above in connection with FIG. 5. In some aspects, the UE 120 may determine ranks from the suitable cells based at least in part on the ranking values determined for the suitable cells. In some aspects, the UE 120 may determine the ranks for the cells by ranking the cells by the ranking values determined for the cells. In this case, the UE 120 may rank the cells using the ranking values without considering the supported slice information. In some aspects, the UE 120 may identify cells with ranking values within a range of the highest ranking value determined for a cell. In this case, the UE 120 may determine that all cells with ranking values within the range of the highest ranking value have a same rank, or the UE 120 may determine ranks for the cells with ranking values within the range of the highest ranking value based at least in part on a determination of whether the cells support the highest priority slice in the intended slice(s).

As further shown in FIG. 8, and by reference number 830, the UE 120 may determine, for each frequency of a plurality of configured frequencies, a respective frequency priority using a highest priority value or a per-cell frequency priority value for the frequency based at least in part on supported slices in the highest ranked cell for the frequency. The per-cell frequency priority values for neighbor frequencies may be included in a SIB broadcast by the serving cell and received by the UE 120. The UE 120 may determine, for a frequency, the highest ranked cell for the frequency based at least in part on the ranks for the cells in that frequency. The UE 120 may determine, based at least in part on the supported slice information, which slices are supported in the highest ranked cell for the frequency.

In some aspects, the UE 120 may determine, for a frequency, that the frequency priority is a highest priority value (e.g., priority 8) based at least in part on a determination that the highest ranked cell for the frequency supports the highest priority slice in the intended slice(s) for the UE 120. In this case, the UE 120 may determine, for a frequency, that the frequency priority value is a per-cell frequency priority value in the highest ranked cell for the frequency based at least in part on a determination that the highest ranked cell for the frequency does not support the highest priority slice in the intended slice(s) for the UE 120.

In some aspects, the UE 120 may determine, for a frequency, that the frequency priority is the highest priority value (e.g., priority 8) based at least in part on a determination that the highest ranked cell for the frequency supports all of the intended slice(s) for the UE 120. In this case, the UE 120 may determine, for a frequency, that the frequency priority value is a per-cell frequency priority value in the highest ranked cell for the frequency based at least in part on a determination that the highest ranked cell for the frequency does not support the at least one slice in the intended slice(s) for the UE 120.

In some aspects, the UE 120 may determine a frequency priority of the serving frequency based at least in part on the supported slices in the serving cell. In some aspects, the UE 120 may determine a highest value frequency priority for the current serving frequency based at least in part on a determination that the serving cell supports all of intended slices for the UE 120. In some aspects, the UE 120 may determine a highest value frequency priority for the current serving frequency based at least in part on a determination that the serving cell supports a highest priority slice included in the one or more intended slices for the UE 120.

As further shown in FIG. 8, and by reference number 835, the UE 120 may select a serving frequency, from the plurality of configured frequencies, based at least in part on the respective frequency priority determined for each frequency of the plurality of configured frequencies. In some aspects, the UE 120 may identify a neighbor frequency (e.g., non-serving frequency) with a highest frequency priority, and the UE 120 may compare the frequency priority for the neighbor frequency with a frequency priority of the current serving frequency. The UE 120 may select to switch to the neighbor frequency with the highest frequency priority or remain on the current serving frequency based at least in part on the comparison. For example, in a case in which the neighbor frequency has a higher frequency priority than the current frequency, the UE 120 may select the neighbor frequency as the serving frequency based at least in part on a determination that the Srxlev value satisfies a threshold associated with switching to a higher priority frequency. In a case, in which the current serving frequency has a higher frequency priority than the neighbor frequency (e.g., due to the current cell supporting the highest priority slice in the intended slice(s) or all of the intended slice(s)), UE 120 may select the neighbor frequency based at least in part on a determination that the Srxlev value of the serving frequency does not satisfy a threshold associated with switching to a lower priority frequency and the Srxlev value of neighbor frequency does satisfy the threshold associated with switching to a lower priority frequency.

As further shown in FIG. 8, and by reference number 840, the UE 120 may camp on a serving cell associated with the selected serving frequency.

As indicated above, FIG. 8 is provided as an example. Other examples may differ from what is described with respect to FIG. 8.

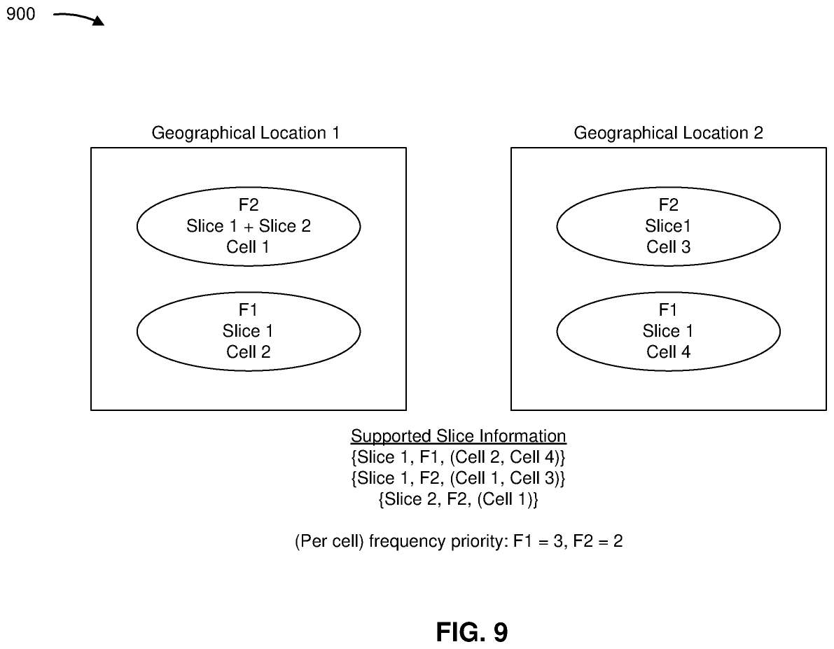

FIG. 9 is a diagram illustrating an example 900 associated with UE slice-specific inter-frequency cell selection, in accordance with the present disclosure. As shown in FIG. 9, example 900 shows an example of inter-frequency cell reselection based at least in part selecting, for each frequency, a highest frequency priority value or a per-cell frequency priority value, as described above in connection with FIG. 8.

As shown in FIG. 9, a UE 120 may receive (e.g., in an SIB or an RRC release message) supported slice information that identifies slices supported in one or more cells (e.g., Cell 1, Cell 2, Cell 3, and Cell 4). For example, the supported slice information may include: {Slice 1, F1, (Cell 2, Cell 4)}; {Slice 1, F2, (Cell 1, Cell 3)}; and {Slice 2; F2, (Cell 1)}. In this case, Slice 1 is supported on a first frequency (F1) on a Cell 2 and Cell 4, Slice 1 is supported on a second frequency (F2) on Cell 1 and Cell 3, and Slice 2 is supported on F2 in Cell 1. As shown in FIG. 9, a per-cell frequency priority for F1 may be 3, and a per-cell frequency priority for F2 may be 2. The intended slices for the UE 120 may include Slice 1 and Slice 2, and Slice 2 may have a higher slice priority than Slice 1 (e.g., Slice 2 may be the highest priority slice in the intended slices).

As shown in FIG. 9, the UE 120 may perform inter-frequency cell reselection in geographical location 1. In this case, the UE 120 may determine that a highest ranked cell for F1 is Cell 2. In some aspects, the UE 120 may determine the frequency priority for F1 based at least in part on a determination of whether the highest ranked cell (Cell 2) for F1 supports a highest priority slice (Slice 2) in the intended slices. The UE 120 may determine, based at least in part on the supported slice information, that Cell 2 does not support Slice 2. Based at least in part on the determination that Cell 2 (e.g., the highest ranked cell for F1) does not support Slice 2 (e.g., the highest priority slice in the intended slices), the UE 120 may determine that that the frequency priority for F1 is the per-cell frequency priority value of 3. The UE 120 may determine that a highest ranked cell for F2 is Cell 1. The UE 120 may determine, based at least in part on the supported slice information, that Cell 1 supports Slice 2. Based at least in part on the determination that Cell 1 (e.g., the highest ranked cell for F2) supports Slice 2 (e.g., the highest priority slice in the intended slices), the UE 120 may determine that the frequency priority for F2 is a highest frequency priority value (e.g., 8). In location 1, the UE 120 may select F2 over F1 based at least in part on a determination the frequency priority of F2 (e.g., 8) is greater than the frequency priority of F1 (e.g., 3).

As further shown in FIG. 9, the UE 120 may perform inter-frequency cell reselection in geographical location 2. In this case, the UE 120 may determine that a highest ranked cell for F1 is Cell 4. The UE 120 may determine, based at least in part on the supported slice information, that Cell 4 does not support Slice 2. Based at least in part on the determination that Cell 4 (e.g., the highest ranked cell for F1) does not support Slice 2 (e.g., the highest priority slice in the intended slices), the UE 120 may determine that that the frequency priority for F1 is the per-cell frequency priority value of 3. The UE 120 may determine that a highest ranked cell for F2 is Cell 3. The UE 120 may determine, based at least in part on the supported slice information, that Cell 3 does not support Slice 2. Based at least in part on the determination that Cell 3 (e.g., the highest ranked cell for F2) does not support Slice 2 (e.g., the highest priority slice in the intended slices), the UE 120 may determine that the frequency priority for F2 is the per-cell frequency priority value of 2. In location 2, the UE 120 may select F1 over F2 based at least in part on a determination the frequency priority of F1 (e.g., 3) is greater than the frequency priority of F2 (e.g., 2).

As indicated above, FIG. 9 is provided as an example. Other examples may differ from what is described with respect to FIG. 9.

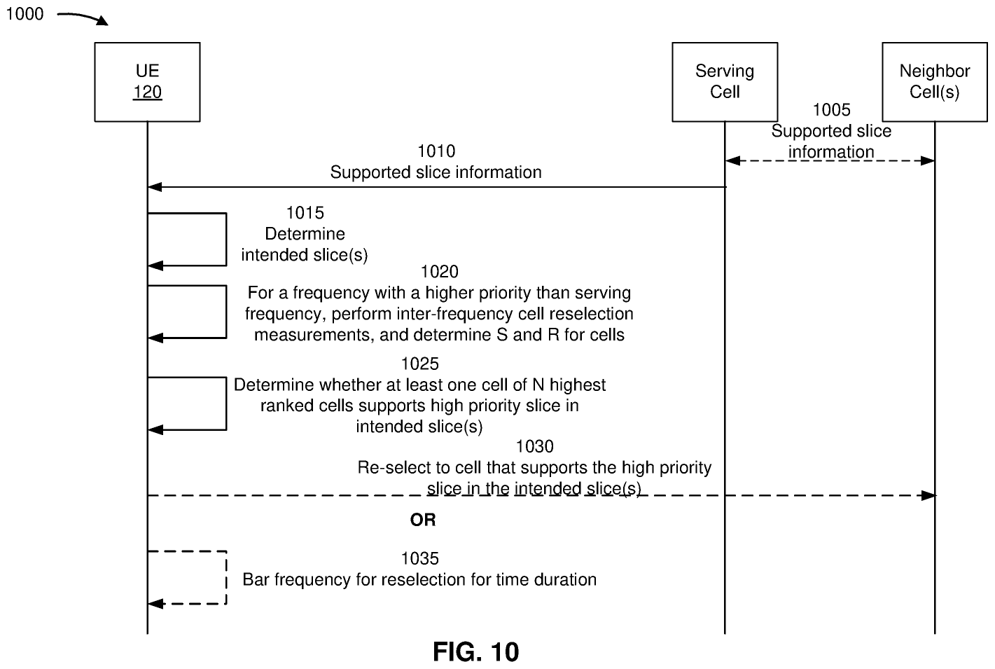

FIG. 10 is a diagram illustrating an example 1000 associated with UE slice-specific inter-frequency cell selection, in accordance with the present disclosure. As shown in FIG. 10, example 1000 includes communication between a UE 120, a serving cell, and one or more neighbor cells. In some aspects, the UE 120 and base stations (e.g., base station 110) associated with the serving cell and the one or more neighbor cells may be included in a wireless network, such as wireless network 100. The UE 120 may communicate with the serving cell (e.g., with a base station associated with the serving cell) and/or each neighbor cell (e.g., a base station associated with each neighbor cell) via a wireless access link, which may include an uplink and a downlink.

As shown in FIG. 10, and by reference number 1005, the serving cell and the one or more neighbor cells may exchange supported slice information via an interface (e.g., the Xn interface) between the base stations associated with the serving cell and the neighbor cells. In some aspects, the supported slice information may be exchanged between the serving cell and the neighbor cells via Xn signaling in Xn setup and/or configuration procedures. In some aspects, the supported slice information may be exchanged between the serving cell and the neighbor cells in an OAM procedure.

In some aspects, the serving cell may receive, from the neighbor cells, supported slice information for the neighbor cells. For example, the supported slice information for a neighbor cell may identify supported slices in the neighbor cell. The supported slice information for the neighbor cell may also identify frequencies on which the supported slices are supported in the neighbor cells.

As further shown in FIG. 10, and by reference number 1010, the UE 120 may receive, from the serving cell, supported slice information for the neighbor cells. In some aspects, the supported slice information for the neighbor cells may identify supported slices in the neighbor cells. For example, the supported slice information may include slice IDs that identify supported slices in the neighbor cells.

In some aspects, the supported slice information may include a list of frequencies, and, for each frequency in the list of frequencies: a list of slice IDs associated with the frequency, and a list of PCIs for each slice ID. For example, a signaling format for the supported slice information (e.g., in an SIB or an RRC release message) may include a list of {frequency, list of [Slice ID, list of PCIs] }.

In some aspects, the supported slice information may include a list of frequencies, and, for each frequency in the list of frequencies: a list of PCIs associated with the frequency and a list of slice IDs for each slice PCI. For example, a signaling format for the supported slice information (e.g., in an SIB or an RRC release message) may include a list of {frequency, list of [PCI, list of Slice IDs] }.

In some aspects, the supported slice information may include a list of slice IDs, and, for each slice ID in the list of slice IDs: a frequency associated with the slice ID, and a list of PCIs for each frequency. For example, a signaling format for the supported slice information (e.g., in an SIB or an RRC release message) may include a list of {slice ID, list of [frequency, list of PCIs] }.

In some aspects, the slice ID may be an S-NSSAI, an SST indication, or a slice index that is mapped to a corresponding S-NSSAI. In some aspects, the slice ID may be a slice group ID associated with a group of slices. For example, a mapping may be configured that maps sets of N-SSAIs to slice groups having corresponding slice group IDs. In this case, a slice group ID may be used to indicate a set of supported slices on a frequency in a cell. This may provide a benefit of reducing payload size for transmitting the supported slice information (e.g., in an SIB or an RRC release message).

In some aspects, the serving cell may transmit the supported slice information (e.g., including the slice IDs, for each frequency, and the per-slice frequency priority values for each slice ID) in an SIB. For example, the serving cell may transmit the supported slice information in a new SIB type (e.g., SIB 15), which may be on-demand broadcast by the serving cell (e.g., based at least in part on receiving a request from the UE 120). This may provide a benefit of reducing a payload size of other broadcast SIB s (e.g., SIB 1).

In some aspects, the serving cell may transmit the supported slice information (e.g., including the slice IDs, for each frequency, and the per-slice frequency priority values for each slice ID) in an RRC release message. For example, the serving cell may transmit the supported slice information to the UE 120 in an RRC release message that causes the UE 120 to switch from an RRC connected mode to an RRC idle mode or an RRC inactive mode. In some aspects, RRC dedicated signaling of the supported slice information (e.g., in the RRC release message) may provide benefits of increase support for RAN sharing and/or faster update speed, as compared to transmitting the slice information in an SIB. In some aspects, dedicated RRC signal of the supported slice information may be used to provide security protection, for example, for sensitive supported slice information.

As further shown in FIG. 10, and by reference number 1015, the UE 120 may determine one or more intended slices for the UE 120. In some aspects, for cell reselection (e.g., intra-frequency cell reselection and/or inter-frequency cell reselection) in an RRC idle mode and/or an RRC inactive mode, the intended slice(s) of the UE 120 may be one or more allowed slices (e.g., allowed S-NSSAI(s)) for the UE 120. In some aspects, for cell reselection in the RRC inactive mode, the intended slice(s) of the UE 120 may be one or more slices (e.g., S-NSSAI(s)) associated with one or more activated PDU sessions with UE context that are suspended when the UE is in the RRC inactive mode.

In some aspects, the UE 120 may determine whether a high priority slice (e.g., an urgent slice) is included in the intended slice(s) of the UE 120. In some aspects, the high priority slice may be a slice with an urgent latency QoS parameter (e.g., an urgent latency requirement). For example, the high priority slice may be at least one uRLLC slice included in the intended slice(s) of the UE 120. In some aspects, each slice in the one or more intended slices may have a respective slice priority value, and a high priority slice may correspond to a slice with a slice priority value that satisfies a threshold. In some aspects, the slice priorities may be determined by the UE 120. In some aspects, the slice priorities may be determined by a base station (e.g., a base station associated with the serving cell) based at least in part on highest ARPs of QoS flows associated with the slices. In some aspects, in connection with a determination that the intended slice(s) of the UE 120 includes a high priority slice, the UE 120 may perform inter-frequency cell reselection based at least in part on the supported slice information.

As further shown in FIG. 10, and by reference number 1020, for a frequency (e.g., a neighbor frequency) with a higher priority than the serving frequency, the UE 120 may perform inter-frequency cell reselection measurements for all cells (e.g., neighbor cells and the serving cell) in that frequency, and the UE 120 may determine the S values and the R value for the cells. In some aspects, based at least in part on a determination that one or more configured frequencies have a higher priority than the serving frequency, the UE 120 may perform the inter-frequency cell reselection measurements and determine the S values and the R value for all cells of each configured frequency with a higher priority than the serving frequency. For example, the priority for each configured frequency may be a per-cell frequency priority value for the frequency. In some aspects, the per-cell frequency priority values may be included in an SIB broadcast by the serving cell and received by the UE 120.

In some aspects, the UE 120 may determine a frequency priority of the serving frequency based at least in part on the supported slices in the serving cell. In some aspects, the UE 120 may determine a highest value frequency priority for the current serving frequency (e.g., instead of a per-cell frequency value for the current serving frequency) based at least in part on a determination that the serving cell supports all of intended slices for the UE 120. In some aspects, the UE 120 may determine the highest value frequency priority for the current serving frequency (e.g., instead of the per-cell frequency value for the current serving frequency) based at least in part on a determination that the serving cell supports a highest priority slice included in the one or more intended slices for the UE 120.

In some aspects, the inter-frequency cell reselection measurements for the cells may include RSRP measurements and/or RSRQ measurements. The UE 120 may determine the S values (e.g., Srxlevl and/or Squal) for the cells based at least in part on the RSRP and RSRQ measurements, for example, as described above in connection with FIG. 5. The UE 120 may determine suitable cells based at least in part on the S values, and the UE 120 may determine ranking values (e.g., R values) for the suitable cells, for example, as described above in connection with FIG. 5. In some aspects, the UE 120 may determine ranks from the suitable cells based at least in part on the ranking values determined for the suitable cells. In some aspects, the UE 120 may determine the ranks for the cells by ranking the cells by the ranking values determined for the cells. In this case, the UE 120 may rank the cells using the ranking values without considering the supported slice information. In some aspects, the UE 120 may identify cells with ranking values within a range of the highest ranking value determined for a cell. In this case, the UE 120 may determine that all cells with ranking values within the range of the highest ranking value have a same rank, or the UE 120 may determine ranks for the cells with ranking values within the range of the highest ranking value based at least in part on a determination of whether the cells support the highest priority slice in the intended slice(s).

As further shown in FIG. 10, and by reference number 1025, the UE 120 may determine, for each frequency with a higher priority than the serving frequency, whether at least one cell, of a number (N) highest ranked cells for the frequency, supports a highest priority slice in the intended slice(s) for the UE 120. In some aspects, the UE 120 may determine, for a frequency, the N highest ranked cells for the frequency based at least in part on the ranks for the cells in that frequency. For example, N may be set using a value specified in a wireless communication standard, configured via UE subscription, and/or configured in a SIB broadcast by the serving cell and received by the UE 120. In some aspects, the UE 120 may determine, based at least in part on the supported slice information, whether any of the N highest ranked cells for the frequency support the highest priority slice in the intended slice(s) for the UE 120.

As further shown in FIG. 10, and by reference number 1030, based at least in part on a determination that at least one of the N highest ranked cells for a frequency support the highest priority slice in the intended slice(s) for the UE 120, the UE 120 may re-select to (e.g., camp on) the a cell, of the N highest ranked cells for the frequency, that supports the highest priority slice in the intended slice(s). In a case in which multiple cells, of the N highest ranked cells for a frequency, support the highest priority slice in the intended slice(s), the UE 120 may reselect to a highest ranked cell of the multiple cells that support the highest priority slice in the intended slice(s).

As further shown in FIG. 10, based at least in part on a determination that no cell, in the N highest ranked cells for a frequency, support the highest priority slice in the intended slice(s), the UE 120 may bar the frequency for reselection for a time duration. For example, in some aspects, the UE 120 may be the frequency for reselection for a maximum time duration of 300 seconds. In some aspects, based at least in part on barring the frequency for reselection, the UE 120 may proceed to a next highest priority frequency with a higher priority than the serving frequency to determine whether at least one cell, of the N highest ranked cells for the next highest priority frequency, supports the highest priority slice in the intended slice(s).

As indicated above, FIG. 10 is provided as an example. Other examples may differ from what is described with respect to FIG. 10.

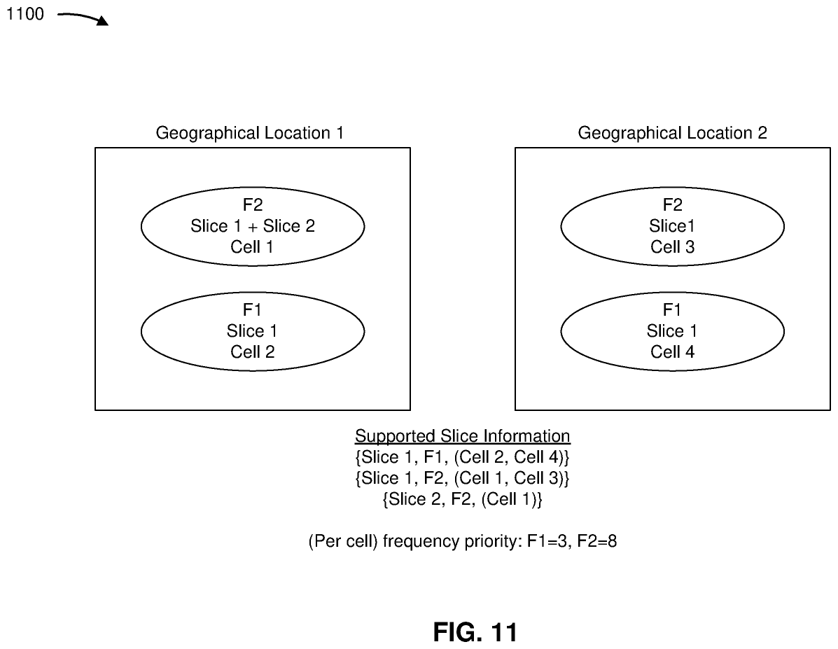

FIG. 11 is a diagram illustrating an example 1100 associated with UE slice-specific inter-frequency cell selection, in accordance with the present disclosure. As shown in FIG. 11, example 1100 shows an example of inter-frequency cell reselection based at least in part selecting, for each frequency, a highest frequency priority value or a per-cell frequency priority value, as described above in connection with FIG. 10.

As shown in FIG. 11, a UE 120 may receive (e.g., in an SIB or an RRC release message) supported slice information that identifies slices supported in one or more cells (e.g., Cell 1, Cell 2, Cell 3, and Cell 4). For example, the supported slice information may include: {Slice 1, F1, (Cell 2, Cell 4)}; {Slice 1, F2, (Cell 1, Cell 3)}; and {Slice 2; F2, (Cell 1)}. In this case, Slice 1 is supported on a first frequency (F1) on a Cell 2 and Cell 4, Slice 1 is supported on a second frequency (F2) on Cell 1 and Cell 3, and Slice 2 is supported on F2 in Cell 1. As shown in FIG. 11, a per-cell frequency priority for F1 may be 3, and a per-cell frequency priority for F2 may be 8. The intended slices for the UE 120 may include Slice 1 and Slice 2, and Slice 2 may have a higher slice priority than Slice 1 (e.g., Slice 2 may be the highest priority slice in the intended slices).

As shown in FIG. 11, the UE 120 may perform inter-frequency cell reselection in geographical location 1. In this case, the UE 120 may determine that F2 has a higher priority (e.g., priority 8) than F1 (e.g., priority 3). The UE 120 may determine that the N highest ranked cells for F2 include Cell 1, which supports Slice 2. Based at least in part on the determination that Cell 1 supports Slice 2 (e.g., the highest ranked slice in the intended slices), the UE 120 may reselect to Cell 1 in F2.

As further shown in FIG. 11, the UE 120 may perform inter-frequency cell reselection in geographical location 2. In this case, the UE 120 may first consider F2 based at least in part on a determination that F2 has a higher priority (e.g., priority 8) than F1 (e.g., priority 3). The UE 120 may determine that the N highest ranked cells for F2, at location 2, include only Cell 3, which does not support Slice 2. Based at least in part on the determination that Cell 3 does not support Slice 2 (e.g., the highest ranked slice in the intended slices), the UE 120 may bar F2 for reselection. In this case, based at least in part on barring F2 for reselection, the UE 120 may reselect to Cell 4 in F1.

As indicated above, FIG. 11 is provided as an example. Other examples may differ from what is described with respect to FIG. 11.

FIG. 12 is a diagram illustrating an example process 1200 performed, for example, by a UE, in accordance with the present disclosure. Example process 1200 is an example where the UE (e.g., UE 120) performs operations associated with UE slice-specific cell selection and reselection.

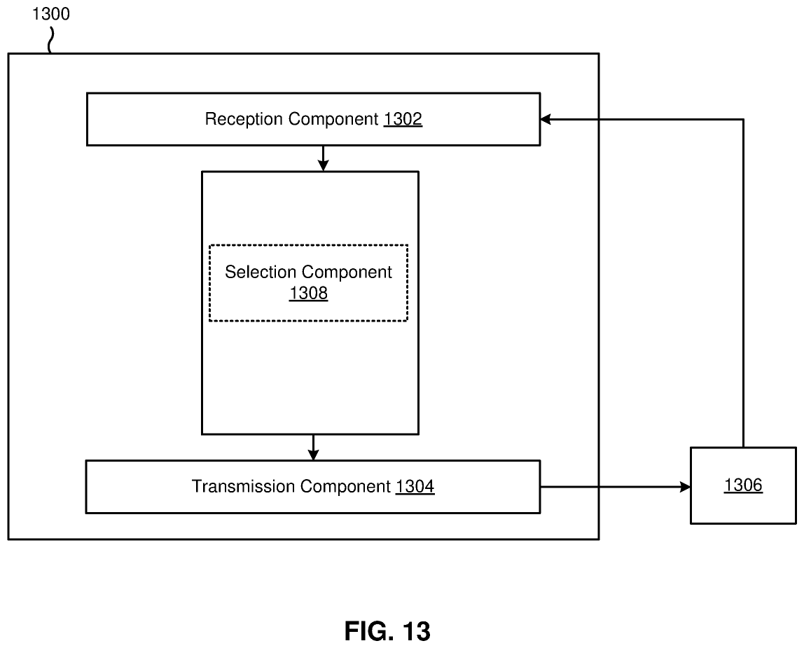

As shown in FIG. 12, in some aspects, process 1200 may include receiving, from a base station, supported slice information (block 1210). For example, the UE (e.g., using reception component 1302, depicted in FIG. 13) may receive, from a base station, supported slice information, as described above.

As further shown in FIG. 12, in some aspects, process 1200 may include performing, in connection with a determination that one or more intended slices for the UE include a high priority slice, at least one of cell selection or cell reselection based at least in part on the supported slice information (block 1220). For example, the UE (e.g., using selection component 1308, depicted in FIG. 13) may perform, in connection with a determination that one or more intended slices for the UE include a high priority slice, at least one of cell selection or cell reselection based at least in part on the supported slice information, as described above.

Process 1200 may include additional aspects, such as any single aspect or any combination of aspects described below and/or in connection with one or more other processes described elsewhere herein.

In a first aspect, the high priority slice is associated with an urgent latency quality of service parameter, and the high priority slice includes at least one uRLLC slice.

In a second aspect, alone or in combination with the first aspect, receiving the supported slice information includes receiving, in a SIB, an indication relating to an urgent slice, and performing at least one of cell selection or cell reselection includes performing, in connection with a determination that the one or more intended slices for the UE include an urgent slice, cell selection based at least in part on the indication.

In a third aspect, alone or in combination with one or more of the first and second aspects, the SIB is a SIB 1, and the indication includes a one bit indication of whether a serving cell associated with the base station supports the urgent slice.

In a fourth aspect, alone or in combination with one or more of the first through third aspects, the SIB is a SIB 1, and the indication includes a three bit indication of an SST for the urgent slice supported by a serving cell associated with the base station.

In a fifth aspect, alone or in combination with one or more of the first through fourth aspects, performing cell selection includes searching for a number of strongest candidate cells in each of a plurality of frequencies, and selecting, as a serving cell, a candidate cell of the number of strongest candidate cells, based at least in part on a determination that the candidate cell supports the urgent slice included in the one or more intended slices for the UE.

In a sixth aspect, alone or in combination with one or more of the first through fifth aspects, searching for the number of strongest candidate cells includes searching for the number of strongest candidate cells in a highest priority PLMN for the UE.

In a seventh aspect, alone or in combination with one or more of the first through sixth aspects, performing at least one of cell selection or cell reselection includes performing intra-frequency cell reselection based at least in part on the supported slice information, and the supported slice information identifies supported slices in a serving cell associated with the base station and supported slices in one or more neighbor cells.

In an eighth aspect, alone or in combination with one or more of the first through seventh aspects, performing intra-frequency cell reselection includes determining, from a plurality of cells including the serving cell and the one or more neighbor cells, a set of suitable cells, determining a respective ranking value for each cell of the set of suitable cells, determining, from the set of suitable cells, a set of candidate cells with ranking values within a range of a highest ranking value for the set of suitable cells, and selecting, from the set of candidate cells, a candidate cell that supports a highest priority slice included in the one or more intended slices for the UE.

In a ninth aspect, alone or in combination with one or more of the first through eighth aspects, performing intra-frequency cell reselection includes determining, from a plurality of cells including the serving cell and the one or more neighbor cells, a set of suitable cells, determining a respective ranking value for each cell of the set of suitable cells, determining, from the set of suitable cells, a set of candidate cells with ranking values within a range of a highest ranking value for the set of suitable cells, and selecting, from the set of candidate cells, a candidate cell that supports all of the intended slices for the UE.

In a tenth aspect, alone or in combination with one or more of the first through ninth aspects, performing intra-frequency cell reselection includes determining, from a plurality of cells including the serving cell and the one or more neighbor cells, a set of suitable cells, determining a respective ranking value for each cell of the set of suitable cells, determining, from the set of suitable cells, a set of candidate cells with ranking values within a range of a highest ranking value for the set of suitable cells, determining, from the set of candidate cells within a ranking range, a set of candidate cells with a highest number of beams, and selecting, from the set of candidate cells, a candidate cell that supports all of the intended slices for the UE.

In an eleventh aspect, alone or in combination with one or more of the first through tenth aspects, performing at least one of cell selection or cell reselection includes performing inter-frequency cell reselection based at least in part on the supported slice information, and the supported slice information includes slice identifiers that identify supported slices in one or more neighbor cells and, one or more per-slice frequency priority values for each slice identifier.

In an twelfth aspect, alone or in combination with one or more of the first through eleventh aspects, the supported slice information includes a list of the slice identifiers, and, for each slice identifier in the list of slice identifiers, a list of frequencies associated with the slice identifier, a per-slice frequency priority value for each frequency in the list of frequencies, and a list of neighbor cells for each frequency in the list of frequencies.

In a thirteenth aspect, alone or in combination with one or more of the first through twelfth aspects, the supported slice information includes a list of frequencies, and, for each frequency in the list of frequencies, a list of slice identifiers associated with the frequency, a per-slice frequency priority value for each slice identifier in the list of slice identifiers, and a list of neighbor cells for each slice identifier in the list of slice identifiers.

In a fourteenth aspect, alone or in combination with one or more of the first through thirteenth aspects, the slice identifiers include at least one of S-NSSAI, SST indications, indexes mapped to corresponding S-NSSAI, or a slice group identifier associated with a group of slices.

In a fifteenth aspect, alone or in combination with one or more of the first through fourteenth aspects, receiving the supported slice information includes receiving the supported slice information including the slice identifiers and the one or more per-slice frequency priority values for each slice identifier in a system information block.

In a sixteenth aspect, alone or in combination with one or more of the first through fifteenth aspects, receiving the one or more per-slice frequency values for each slice identifier in the system information block overwrites per-cell frequency priority values received in the system information block.

In a seventeenth aspect, alone or in combination with one or more of the first through sixteenth aspects, receiving the supported slice information includes receiving the supported slice information including the slice identifiers and the one or more per-slice frequency priority values for each slice identifier in a radio resource control release message.

In a eighteenth aspect, alone or in combination with one or more of the first through seventeenth aspects, receiving the one or more per-slice frequency values for each slice identifier in the radio resource control release message overwrites frequency priority values received in a system information block.

In an nineteenth aspect, alone or in combination with one or more of the first through eighteenth aspects, the supported slice information is exchanged among the one or more neighbor cells and a serving cell via an Xn interface during at least one of an Xn setup procedure or an Xn configuration update procedure.

In a twentieth aspect, alone or in combination with one or more of the first through nineteenth aspects, performing inter-frequency cell reselection includes performing inter-frequency cell reselection measurements for a serving cell and the one or more neighbor cells based at least in part on a determination that a neighbor cell, of the one or more neighbor cells, supports a highest priority slice included in the one or more intended slices for the UE, determining ranks for the serving cell and the one or more neighbor cells based at least in part on the inter-frequency cell reselection measurements, determining, for each frequency in a plurality of configured frequencies, a respective frequency priority based at least in part on a supported slice with a highest per-slice frequency priority value in a highest ranked cell for that frequency, and selecting a serving frequency, from the plurality of configured frequencies, based at least in part on the respective frequency priority determined for each frequency of the plurality of configured frequencies.

In a twenty-first aspect, alone or in combination with one or more of the first through twentieth aspects, the plurality of configured frequencies includes a current serving frequency, and determining, for each frequency of a plurality of configured frequencies, a respective frequency priority includes determining a highest value frequency priority for the current serving frequency based at least in part on a determination that the serving cell supports all of intended slices for the UE.

In a twenty-second aspect, alone or in combination with one or more of the first through twenty-first aspects, the plurality of configured frequencies includes a current serving frequency, and determining, for each frequency of a plurality of configured frequencies, a respective frequency priority includes determining a highest value frequency priority for the current serving frequency based at least in part on a determination that the serving cell supports a highest priority slice included in the one or more intended slices for the UE.

In a twenty-third aspect, alone or in combination with one or more of the first through twenty-second aspects, performing at least one of cell selection or cell reselection includes performing inter-frequency cell reselection based at least in part on the supported slice information, and the supported slice information identifies supported slices in one or more neighbor cells.

In a twenty-fourth aspect, alone or in combination with one or more of the first through twenty-third aspects, performing inter-frequency cell reselection includes performing inter-frequency cell reselection measurements for a serving cell and the one or more neighbor cells based at least in part on a determination that a neighbor cell, of the one or more neighbor cells, supports a highest priority slice included in the one or more intended slices for the UE, determining ranks for the serving cell and the one or more neighbor cells based at least in part on the inter-frequency cell reselection measurements, determining, for each frequency in a plurality of configured frequencies, a respective frequency priority as one of a highest frequency priority value, based at least in part on a determination that a highest ranked cell associated with that frequency supports a highest priority slice included in the one or more intended slices for the UE, or a per-cell frequency priority value for that frequency in the highest ranked cell associated with that frequency, based at least in part on a determination that the highest ranked cell associated with that frequency does not support the highest priority slice included in the one or more intended slices for the UE, and selecting a serving frequency, from the plurality of configured frequencies, based at least in part on the respective frequency priority determined for each frequency of the plurality of configured frequencies.

In a twenty-fifth aspect, alone or in combination with one or more of the first through twenty-fourth aspects, performing inter-frequency cell reselection includes performing inter-frequency cell reselection measurements for a serving cell and the one or more neighbor cells based at least in part on a determination that a neighbor cell, of the one or more neighbor cells, supports a highest priority slice included in the one or more intended slices for the UE, determining ranks for the serving cell and the one or more neighbor cells based at least in part on the inter-frequency cell reselection measurements, determining, for each frequency in a plurality of configured frequencies, a respective frequency priority as one of a highest frequency priority value, based at least in part on a determination that a highest ranked cell associated with that frequency supports all of the one or more intended slices for the UE, or a per-cell frequency priority value for that frequency in the highest ranked cell associated with that frequency, based at least in part on a determination that the highest ranked cell associated with that frequency does not support at least one slice of the one or more intended slices for the UE, and selecting a serving frequency, from the plurality of configured frequencies, based at least in part on the respective frequency priority determined for each frequency of the plurality of configured frequencies.

In a twenty-sixth aspect, alone or in combination with one or more of the first through twenty-fifth aspects, performing inter-frequency cell reselection includes performing inter-frequency cell reselection measurements, for a frequency having a higher priority than a serving frequency, in at least one of a serving cell and the one or more neighbor cells, determining ranks for the serving cell and the one or more neighbor cells based at least in part on the inter-frequency cell reselection measurements, determining, whether at least one cell of a number of highest ranked cells support the high priority slice included in the one or more intended slices for the UE, and reselecting to the frequency in a cell, of the number of highest ranked cells, that supports the high priority slice based at least in part on a determination that at least one cell of the number of highest ranked cells supports the high priority slice included in the one or more intended slices for the UE, or barring the frequency for reselection for a time duration, based at least in part on a determination that no cell in the number of highest ranked cells supports the high priority slice included in the one or more intended slices for the UE.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a block diagram of an example apparatus 1300 for wireless communication. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a selection component 1308, among other examples.

In some aspects, the apparatus 1300 may be configured to perform one or more operations described herein in connection with FIGS. 4-11. Additionally, or alternatively, the apparatus 1300 may be configured to perform one or more processes described herein, such as process 1200 of FIG. 12, or a combination thereof. In some aspects, the apparatus 1300 and/or one or more components shown in FIG. 13 may include one or more components of the UE described above in connection with FIG. 2. Additionally, or alternatively, one or more components shown in FIG. 13 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1306. In some aspects, the reception component 1302 may include one or more antennas, a demodulator, a MIMO detector, a receive processor, a controller/processor, a memory, or a combination thereof, of the UE described above in connection with FIG. 2.

The transmission component 1304 may transmit communications, such as reference signals, control information, data communications, or a combination thereof, to the apparatus 1306. In some aspects, one or more other components of the apparatus 1306 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modulator, a transmit MIMO processor, a transmit processor, a controller/processor, a memory, or a combination thereof, of the UE described above in connection with FIG. 2. In some aspects, the transmission component 1304 may be co-located with the reception component 1302 in a transceiver.

The reception component 1302 may receive, from a base station, supported slice information. The selection component 1308 may perform, in connection with a determination that one or more intended slices for the UE include a high priority slice, at least one of cell selection or cell reselection based at least in part on the supported slice information.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving, from a base station, supported slice information; and performing, in connection with a determination that one or more intended slices for the UE include a high priority slice, at least one of cell selection or cell reselection based at least in part on the supported slice information.

Aspect 2: The method of Aspect 1, wherein the high priority slice is associated with an urgent latency quality of service parameter, and wherein the high priority slice includes at least one ultra-reliable low-latency communication (uRLLC) slice.

Aspect 3: The method of any of Aspects 1-2, wherein receiving the supported slice information comprises: receiving, in a system information block (SIB), an indication relating to an urgent slice; and wherein performing at least one of cell selection or cell reselection comprises: performing, in connection with a determination that the one or more intended slices for the UE include an urgent slice, cell selection based at least in part on the indication.

Aspect 4: The method of Aspect 3, wherein the SIB is a type 1 SIB (SIB 1), and the indication includes a one bit indication of whether a serving cell associated with the base station supports the urgent slice.

Aspect 5: The method of Aspect 3, wherein the SIB is a type 1 SIB (SIB 1), and the indication includes a three bit indication of a slice/service type (SST) for the urgent slice supported by a serving cell associated with the base station.

Aspect 6: The method of any of Aspects 3-5, wherein performing cell selection comprises: searching for a number of strongest candidate cells in each of a plurality of frequencies; and selecting, as a serving cell, a candidate cell of the number of strongest candidate cells, based at least in part on a determination that the candidate cell supports the urgent slice included in the one or more intended slices for the UE.

Aspect 7: The method of Aspect 6, wherein searching for the number of strongest candidate cells comprises: searching for the number of strongest candidate cells in a highest priority public land mobile network for the UE.

Aspect 8: The method of any of Aspects 1-7, wherein performing at least one of cell selection or cell reselection comprises: performing intra-frequency cell reselection based at least in part on the supported slice information, wherein the supported slice information identifies supported slices in a serving cell associated with the base station and supported slices in one or more neighbor cells.

Aspect 9: The method of Aspect 8, wherein performing intra-frequency cell reselection comprises: determining, from a plurality of cells including the serving cell and the one or more neighbor cells, a set of suitable cells; determining a respective ranking value for each cell of the set of suitable cells; determining, from the set of suitable cells, a set of candidate cells with ranking values within a range of a highest ranking value for the set of suitable cells; and selecting, from the set of candidate cells, a candidate cell that supports a highest priority slice included in the one or more intended slices for the UE.

Aspect 10: The method of Aspect 8, wherein performing intra-frequency cell reselection comprises: determining, from a plurality of cells including the serving cell and the one or more neighbor cells, a set of suitable cells; determining a respective ranking value for each cell of the set of suitable cells; determining, from the set of suitable cells, a set of candidate cells with ranking values within a range of a highest ranking value for the set of suitable cells; and selecting, from the set of candidate cells, a candidate cell that supports all of the intended slices for the UE.

Aspect 11: The method of Aspect 8, wherein performing intra-frequency cell reselection comprises: determining, from a plurality of cells including the serving cell and the one or more neighbor cells, a set of suitable cells; determining a respective ranking value for each cell of the set of suitable cells; determining, from the set of suitable cells, a set of candidate cells with ranking values within a range of a highest ranking value for the set of suitable cells; determining, from the set of candidate cells within a ranking range, a set of candidate cells with a highest number of beams; and selecting, from the set of candidate cells, a candidate cell that supports all of the intended slices for the UE.

Aspect 12: The method of any of Aspects 1-11, wherein performing at least one of cell selection or cell reselection comprises: performing inter-frequency cell reselection based at least in part on the supported slice information, wherein the supported slice information includes slice identifiers that identify supported slices in one or more neighbor cells and, one or more per-slice frequency priority values for each slice identifier.

Aspect 13: The method of Aspect 12, wherein the supported slice information includes a list of the slice identifiers, and, for each slice identifier in the list of slice identifiers, a list of frequencies associated with the slice identifier, a per-slice frequency priority value for each frequency in the list of frequencies, and a list of neighbor cells for each frequency in the list of frequencies.

Aspect 14: The method of Aspect 12, wherein the supported slice information includes a list of frequencies, and, for each frequency in the list of frequencies, a list of slice identifiers associated with the frequency, a per-slice frequency priority value for each slice identifier in the list of slice identifiers, and a list of neighbor cells for each slice identifier in the list of slice identifiers.

Aspect 15: The method of any of Aspects 12-14, wherein the slice identifiers include at least one of single-network slice selection assistance information (S-NSSAI), slice/service type (SST) indications, indexes mapped to corresponding S-NSSAI, or a slice group identifier associated with a group of slices.

Aspect 16: The method of any of Aspects 12-15, wherein receiving the supported slice information comprises: receiving the supported slice information including the slice identifiers and the one or more per-slice frequency priority values for each slice identifier in a system information block.

Aspect 17: The method of Aspect 16, wherein receiving the one or more per-slice frequency values for each slice identifier in the system information block overwrites per-cell frequency priority values received in the system information block.

Aspect 18: The method of any of Aspects 12-15, wherein receiving the supported slice information comprises: receiving the supported slice information including the slice identifiers and the one or more per-slice frequency priority values for each slice identifier in a radio resource control release message.

Aspect 19: The method of Aspect 18, wherein receiving the one or more per-slice frequency values for each slice identifier in the radio resource control release message overwrites frequency priority values received in a system information block.

Aspect 20: The method of any of Aspects 12-19, wherein the supported slice information is exchanged among the one or more neighbor cells and a serving cell via an Xn interface during at least one of an Xn setup procedure or an Xn configuration update procedure.

Aspect 21: The method of any of Aspects 12-20, wherein performing inter-frequency cell reselection comprises: performing inter-frequency cell reselection measurements for a serving cell and the one or more neighbor cells based at least in part on a determination that a neighbor cell, of the one or more neighbor cells, supports a highest priority slice included in the one or more intended slices for the UE; determining ranks for the serving cell and the one or more neighbor cells based at least in part on the inter-frequency cell reselection measurements; determining, for each frequency in a plurality of configured frequencies, a respective frequency priority based at least in part on a supported slice with a highest per-slice frequency priority value in a highest ranked cell for that frequency; and selecting a serving frequency, from the plurality of configured frequencies, based at least in part on the respective frequency priority determined for each frequency of the plurality of configured frequencies.

Aspect 22: The method of Aspect 21, wherein the plurality of configured frequencies includes a current serving frequency, and determining, for each frequency of a plurality of configured frequencies, a respective frequency priority comprises: determining a highest value frequency priority for the current serving frequency based at least in part on a determination that the serving cell supports all of intended slices for the UE.

Aspect 23: The method of Aspect 21, wherein the plurality of configured frequencies includes a current serving frequency, and determining, for each frequency of a plurality of configured frequencies, a respective frequency priority comprises: determining a highest value frequency priority for the current serving frequency based at least in part on a determination that the serving cell supports a highest priority slice included in the one or more intended slices for the UE.

Aspect 24: The method of any of Aspects 1-11, wherein performing at least one of cell selection or cell reselection comprises: performing inter-frequency cell reselection based at least in part on the supported slice information, wherein the supported slice information identifies supported slices in one or more neighbor cells.

Aspect 25: The method of Aspect 24, wherein performing inter-frequency cell reselection comprises: performing inter-frequency cell reselection measurements for a serving cell and the one or more neighbor cells based at least in part on a determination that a neighbor cell, of the one or more neighbor cells, supports a highest priority slice included in the one or more intended slices for the UE; determining ranks for the serving cell and the one or more neighbor cells based at least in part on the inter-frequency cell reselection measurements; determining, for each frequency in a plurality of configured frequencies, a respective frequency priority as one of: a highest frequency priority value, based at least in part on a determination that a highest ranked cell associated with that frequency supports a highest priority slice included in the one or more intended slices for the UE, or a per-cell frequency priority value for that frequency in the highest ranked cell associated with that frequency, based at least in part on a determination that the highest ranked cell associated with that frequency does not support the highest priority slice included in the one or more intended slices for the UE; and selecting a serving frequency, from the plurality of configured frequencies, based at least in part on the respective frequency priority determined for each frequency of the plurality of configured frequencies.

Aspect 26: The method of Aspect 24, wherein performing inter-frequency cell reselection comprises: performing inter-frequency cell reselection measurements for a serving cell and the one or more neighbor cells based at least in part on a determination that a neighbor cell, of the one or more neighbor cells, supports a highest priority slice included in the one or more intended slices for the UE; determining ranks for the serving cell and the one or more neighbor cells based at least in part on the inter-frequency cell reselection measurements; determining, for each frequency in a plurality of configured frequencies, a respective frequency priority as one of: a highest frequency priority value, based at least in part on a determination that a highest ranked cell associated with that frequency supports all of the one or more intended slices for the UE, or a per-cell frequency priority value for that frequency in the highest ranked cell associated with that frequency, based at least in part on a determination that the highest ranked cell associated with that frequency does not support at least one slice of the one or more intended slices for the UE; and selecting a serving frequency, from the plurality of configured frequencies, based at least in part on the respective frequency priority determined for each frequency of the plurality of configured frequencies.

Aspect 27: The method of Aspect 24, wherein performing inter-frequency cell reselection comprises: performing inter-frequency cell reselection measurements, for a frequency having a higher priority than a serving frequency, in at least one of a serving cell and the one or more neighbor cells; determining ranks for the serving cell and the one or more neighbor cells based at least in part on the inter-frequency cell reselection measurements; determining, whether at least one cell of a number of highest ranked cells support the high priority slice included in the one or more intended slices for the UE; and reselecting to the frequency in a cell, of the number of highest ranked cells, that supports the high priority slice based at least in part on a determination that at least one cell of the number of highest ranked cells supports the high priority slice included in the one or more intended slices for the UE, or barring the frequency for reselection for a time duration, based at least in part on a determination that no cell in the number of highest ranked cells supports the high priority slice included in the one or more intended slices for the UE.

Aspect 28: An apparatus for wireless communication at a device, comprising a processor; memory coupled with the processor; and instructions stored in the memory and executable by the processor to cause the apparatus to perform the method of one or more of Aspects 1-27.

Aspect 29: A device for wireless communication, comprising a memory and one or more processors coupled to the memory, the memory and the one or more processors configured to perform the method of one or more of Aspects 1-27.

Aspect 30: An apparatus for wireless communication, comprising at least one means for performing the method of one or more of Aspects 1-27.

Aspect 31: A non-transitory computer-readable medium storing code for wireless communication, the code comprising instructions executable by a processor to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

Example Proposals 1-13, included below, provide examples of proposals to the 3GPP relating to the present disclosure. Example Proposals 1-13 may include example proposals for a wireless communication standard promulgated by the 3GPP. It is to be noted, however, that Example Proposals 1-13 are purely exemplary and therefore are not to considered limiting of the scope of this disclosure or the aspects described above.

Example Proposal 1: Proposal to prioritize scenario of geographical location 1 and 2, which are target for one scenario with slice specific frequency priority and area specific frequency priority.

Example Proposal 2: Update the definition of “intended slice” for slice specific cell reselection as follows: For requesting new S-NSSAI(s): intended slices=Requested S-NSSAI(s); For idle-mode mobility: intended slices=allowed S-NSSAI(s) for RRC_IDLE UE, and intended slices=is S-NSSAI(s) associated with activated PDU Sessions with UE context suspended for RRC_INACTIVE UE.

Example Proposals 3-7 relate to signal for cell reselection.

Example Proposal 3: Introduce a new SIB type (e.g., SIB 15) to include the supported slice information of the current cell and neighbor cells and cell reselection priority per slice. The new SIB can be on-demand broadcast to reduce payload size of SIB.

Example Proposal 4: To further reduce payload size, introduce slice grouping via a configured mapping from a set of S-NSSAIs to a slice group.

Example Proposal 5: There is no security/privacy concern to broadcast slice group ID in SIB, and Network can use dedicated RRC signaling with security protection to provide some sensitive slice supporting.

Example Proposal 6: The signaling format to support slice specific cell reselection is: a list of {frequency, list of [Slice group ID, frequency priority value, list of PCIs]}, where frequency priority value reuse legacy range of 0-7.

Example Proposal 7: It is up to UE implementation to determine the slice priority in this release if its intended slices includes more than one S-NSSAI.

Example Proposals 8-11 relate to UE behavior of cell reselection.

Example Proposal 8: No spec change on criteria-S calculation is required in slice specific cell reselection.

Example Proposal 9: To ensure UE does not lose coverage due to slice prioritization, two alternatives of criteria-R for intra-frequency cell reselection: Alt-1: No spec change on criteria-R calculation (i.e., supported slice info is not considered in intra-frequency cell reselection); Alt-2: The UE may check cells whose R-value within a range rangeToBestCellSlice (if configured in SIB). Among them, the cells(s) which provide UE's all the intended slice(s) are candidates for cell reselection. If there are multiple such cells, the UE shall reselect to the cell with largest R-value which becomes the highest ranked cell.

Example Proposal 10: If the camped cell provides UE's all intended slices, the UE may consider the serving frequency as highest priority.

Example Proposal 11: For inter-frequency cell reselection, the UE may determine priority of one neighbor frequency via below approach: If (any) one cell provides slice with highest priority supported by the UE, the UE performs measurements for that frequency irrespective of S_{nonIntraSearchP}/S_{nonIntraSearchQ} to get the best ranked cell; UE derives the frequency priority with the priority value corresponding to the highest priority slice supported by the highest ranked cell.

Example Proposals 12-13 relate to a legacy issue when cell specific frequency priority is provided in SIB and UE specific frequency priority is provided in RRC release message, and per-slice priority is also configured in either SIB/RRC release.

Example Proposal 12: If frequency priority per slice group is provided via only SIB (i.e., priority is not configured in RRC release), the UE supporting slice specific cell reselection shall ignore the cell specific frequency priority in SIB.

Example Proposal 13: RRC release message should provide either UE specific frequency priority or frequency priority per slice group (i.e., not both). And if provided in RRC release, the UE shall ignore cell specific and/or slice specific priority provided in SIB.

What is claimed is:

1. A method of wireless communication performed by a user equipment (UE), comprising:
receiving, from a base station, supported slice information; and
performing, in connection with a determination that one or more intended slices for the UE include a high priority slice, at least one of cell selection or cell reselection based at least in part on the supported slice information.

2. The method of claim 1, wherein the high priority slice is associated with an urgent latency quality of service parameter, and wherein the high priority slice includes at least one ultra-reliable low-latency communication (uRLLC) slice.

3. The method of claim 1, wherein receiving the supported slice information comprises:
receiving, in a system information block (SIB), an indication relating to an urgent slice; and
wherein performing at least one of cell selection or cell reselection comprises:
performing, in connection with a determination that the one or more intended slices for the UE include an urgent slice, cell selection based at least in part on the indication.

4. The method of claim 3, wherein the SIB is a type 1 SIB (SIB 1), and the indication includes a one bit indication of whether a serving cell associated with the base station supports the urgent slice.

5. The method of claim 3, wherein the SIB is a type 1 SIB (SIB 1), and the indication includes a three bit indication of a slice/service type (SST) for the urgent slice supported by a serving cell associated with the base station.

6. The method of claim 3, wherein performing cell selection comprises:
searching for a number of strongest candidate cells in each of a plurality of frequencies; and
selecting, as a serving cell, a candidate cell of the number of strongest candidate cells, based at least in part on a determination that the candidate cell supports the urgent slice included in the one or more intended slices for the UE.

7. The method of claim 6, wherein searching for the number of strongest candidate cells comprises:
searching for the number of strongest candidate cells in a highest priority public land mobile network for the UE.

8. The method of claim 1, wherein performing at least one of cell selection or cell reselection comprises:
performing intra-frequency cell reselection based at least in part on the supported slice information, wherein the supported slice information identifies supported slices in a serving cell associated with the base station and supported slices in one or more neighbor cells.

9. The method of claim 8, wherein performing intra-frequency cell reselection comprises:
determining, from a plurality of cells including the serving cell and the one or more neighbor cells, a set of suitable cells;
determining a respective ranking value for each cell of the set of suitable cells;
determining, from the set of suitable cells, a set of candidate cells with ranking values within a range of a highest ranking value for the set of suitable cells; and
selecting, from the set of candidate cells, a candidate cell that supports a highest priority slice included in the one or more intended slices for the UE.

10. The method of claim 8, wherein performing intra-frequency cell reselection comprises:
determining, from a plurality of cells including the serving cell and the one or more neighbor cells, a set of suitable cells;
determining a respective ranking value for each cell of the set of suitable cells;
determining, from the set of suitable cells, a set of candidate cells with ranking values within a range of a highest ranking value for the set of suitable cells; and
selecting, from the set of candidate cells, a candidate cell that supports all of the intended slices for the UE.

11. The method of claim 8, wherein performing intra-frequency cell reselection comprises:
determining, from a plurality of cells including the serving cell and the one or more neighbor cells, a set of suitable cells;
determining a respective ranking value for each cell of the set of suitable cells;
determining, from the set of suitable cells, a set of candidate cells with ranking values within a range of a highest ranking value for the set of suitable cells;
determining, from the set of candidate cells within a ranking range, a set of candidate cells with a highest number of beams; and
selecting, from the set of candidate cells, a candidate cell that supports all of the intended slices for the UE.

12. The method of claim 1, wherein performing at least one of cell selection or cell reselection comprises:
performing inter-frequency cell reselection based at least in part on the supported slice information, wherein the supported slice information includes slice identifiers that identify supported slices in one or more neighbor cells and, one or more per-slice frequency priority values for each slice identifier.

13. The method of claim 12, wherein the supported slice information includes a list of the slice identifiers, and, for each slice identifier in the list of slice identifiers, a list of frequencies associated with the slice identifier, a per-slice frequency priority value for each frequency in the list of frequencies, and a list of neighbor cells for each frequency in the list of frequencies.

14. The method of claim 12, wherein the supported slice information includes a list of frequencies, and, for each frequency in the list of frequencies, a list of slice identifiers associated with the frequency, a per-slice frequency priority value for each slice identifier in the list of slice identifiers, and a list of neighbor cells for each slice identifier in the list of slice identifiers.

15. The method of claim 12, wherein the slice identifiers include at least one of single-network slice selection assistance information (S-NSSAI), slice/service type (SST) indications, indexes mapped to corresponding S-NSSAI, or a slice group identifier associated with a group of slices.

16. The method of claim 12, wherein receiving the supported slice information comprises:
receiving the supported slice information including the slice identifiers and the one or more per-slice frequency priority values for each slice identifier in a system information block.

17. The method of claim 16, wherein receiving the one or more per-slice frequency values for each slice identifier in the system information block overwrites per-cell frequency priority values received in the system information block.

18. The method of claim 12, wherein receiving the supported slice information comprises:
receiving the supported slice information including the slice identifiers and the one or more per-slice frequency priority values for each slice identifier in a radio resource control release message.

19. The method of claim 18, wherein receiving the one or more per-slice frequency values for each slice identifier in the radio resource control release message overwrites frequency priority values received in a system information block.

20. The method of claim 12, wherein the supported slice information is exchanged among the one or more neighbor cells and a serving cell via an Xn interface during at least one of an Xn setup procedure or an Xn configuration update procedure.

21. The method of claim 12, wherein performing inter-frequency cell reselection comprises:
performing inter-frequency cell reselection measurements for a serving cell and the one or more neighbor cells based at least in part on a determination that a neighbor cell, of the one or more neighbor cells, supports a highest priority slice included in the one or more intended slices for the UE;
determining ranks for the serving cell and the one or more neighbor cells based at least in part on the inter-frequency cell reselection measurements;
determining, for each frequency in a plurality of configured frequencies, a respective frequency priority based at least in part on a supported slice with a highest per-slice frequency priority value in a highest ranked cell for that frequency; and
selecting a serving frequency, from the plurality of configured frequencies, based at least in part on the respective frequency priority determined for each frequency of the plurality of configured frequencies.

22. The method of claim 21, wherein the plurality of configured frequencies includes a current serving frequency, and determining, for each frequency of a plurality of configured frequencies, a respective frequency priority comprises:
determining a highest value frequency priority for the current serving frequency based at least in part on a determination that the serving cell supports all of intended slices for the UE.

23. The method of claim 21, wherein the plurality of configured frequencies includes a current serving frequency, and determining, for each frequency of a plurality of configured frequencies, a respective frequency priority comprises:
determining a highest value frequency priority for the current serving frequency based at least in part on a determination that the serving cell supports a highest priority slice included in the one or more intended slices for the UE.

24. The method of claim 21, wherein performing at least one of cell selection or cell reselection comprises:
performing inter-frequency cell reselection based at least in part on the supported slice information, wherein the supported slice information identifies supported slices in one or more neighbor cells.

25. The method of claim 24, wherein performing inter-frequency cell reselection comprises:
performing inter-frequency cell reselection measurements for a serving cell and the one or more neighbor cells based at least in part on a determination that a neighbor cell, of the one or more neighbor cells, supports a highest priority slice included in the one or more intended slices for the UE;
determining ranks for the serving cell and the one or more neighbor cells based at least in part on the inter-frequency cell reselection measurements;
determining, for each frequency in a plurality of configured frequencies, a respective frequency priority as one of:
a highest frequency priority value, based at least in part on a determination that a highest ranked cell associated with that frequency supports a highest priority slice included in the one or more intended slices for the UE, or
a per-cell frequency priority value for that frequency in the highest ranked cell associated with that frequency, based at least in part on a determination that the highest ranked cell associated with that frequency does not support the highest priority slice included in the one or more intended slices for the UE; and
selecting a serving frequency, from the plurality of configured frequencies, based at least in part on the respective frequency priority determined for each frequency of the plurality of configured frequencies.

26. The method of claim 24, wherein performing inter-frequency cell reselection comprises:
performing inter-frequency cell reselection measurements for a serving cell and the one or more neighbor cells based at least in part on a determination that a neighbor cell, of the one or more neighbor cells, supports a highest priority slice included in the one or more intended slices for the UE;
determining ranks for the serving cell and the one or more neighbor cells based at least in part on the inter-frequency cell reselection measurements;
determining, for each frequency in a plurality of configured frequencies, a respective frequency priority as one of:
a highest frequency priority value, based at least in part on a determination that a highest ranked cell associated with that frequency supports all of the one or more intended slices for the UE, or
a per-cell frequency priority value for that frequency in the highest ranked cell associated with that frequency, based at least in part on a determination that the highest ranked cell associated with that frequency does not support at least one slice of the one or more intended slices for the UE; and
selecting a serving frequency, from the plurality of configured frequencies, based at least in part on the respective frequency priority determined for each frequency of the plurality of configured frequencies.

27. The method of claim 24, wherein performing inter-frequency cell reselection comprises:
performing inter-frequency cell reselection measurements, for a frequency having a higher priority than a serving frequency, in at least one of a serving cell and the one or more neighbor cells;
determining ranks for the serving cell and the one or more neighbor cells based at least in part on the inter-frequency cell reselection measurements;
determining, whether at least one cell of a number of highest ranked cells support the high priority slice included in the one or more intended slices for the UE; and
reselecting to the frequency in a cell, of the number of highest ranked cells, that supports the high priority slice based at least in part on a determination that at least one cell of the number of highest ranked cells supports the high priority slice included in the one or more intended slices for the UE, or
barring the frequency for reselection for a time duration, based at least in part on a determination that no cell in the number of highest ranked cells supports the high priority slice included in the one or more intended slices for the UE.

28. A user equipment (UE) for wireless communication, comprising:
a memory; and
one or more processors, coupled to the memory, configured to:
receive, from a base station, supported slice information; and
perform, in connection with a determination that one or more intended slices for the UE include a high priority slice, at least one of cell selection or cell reselection based at least in part on the supported slice information.

29. The UE of claim 28, wherein the one or more processors, to perform at least one of cell selection or cell reselection, are configured to:
perform inter-frequency cell reselection based at least in part on the supported slice information, wherein the supported slice information includes slice identifiers that identify supported slices in one or more neighbor cells and, one or more per-slice frequency priority values for each slice identifier.

30. A non-transitory computer-readable medium storing a set of instructions for wireless communication, the set of instructions comprising:
one or more instructions that, when executed by one or more processors of a user equipment (UE), cause the UE to:
receive, from a base station, supported slice information; and
perform, in connection with a determination that one or more intended slices for the UE include a high priority slice, at least one of cell selection or cell reselection based at least in part on the supported slice information.

31. An apparatus for wireless communication, comprising:
means for receiving, from a base station, supported slice information; and
means for performing, in connection with a determination that one or more intended slices include a high priority slice, at least one of cell selection or cell reselection based at least in part on the supported slice information.
